SEQUENCE LISTING (29 sequences)

SEQ ID NO: 1 - DNA, 3912 bp, Saccharomyces cerevisiae
atggtgcagttagccaaagtcccaattctaggaaatgatattatccacgttgggtataacattcatgaccatttggttgaaaccataattaaacattgtccttcttcgacatacgttatttgcaatgatacgaacttgagtaaagttccatactaccagcaattagtcctggaattcaaggcttctttgccagaaggctctcgtttacttacttatgttgttaaaccaggtgagacaagtaaaagtagagaaaccaaagcgcagctagaagattatcttttagtggaaggatgtactcgtgatacggttatggtagcgatcggtggtggtgttattggtgacatgattgggttcgttgcatctacatttatgagaggtgttcgtgttgtccaagtaccaacatccttattggcaatggtcgattcctccattggtggtaaaactgctattgacactcctctaggtaaaaactttattggtgcattttggcaaccaaaatttgtccttgtagatattaaatggctagaaacgttagccaagagagagtttatcaatgggatggcagaagttatcaagactgcttgtatttggaacgctgacgaatttactagattagaatcaaacgcttcgttgttcttaaatgttgttaatggggcaaaaaatgtcaaggttaccaatcaattgacaaacgagattgacgagatatcgaatacagatattgaagctatgttggatcatacatataagttagttcttgagagtattaaggtcaaagcggaagttgtctcttcggatgaacgtgaatccagtctaagaaaccttttgaacttcggacattctattggtcatgcttatgaagctatactaaccccacaagcattacatggtgaatgtgtgtccattggtatggttaaagaggcggaattatcccgttatttcggtattctctcccctacccaagttgcacgtctatccaagattttggttgcctacgggttgcctgtttcgcctgatgagaaatggtttaaagagctaaccttacataagaaaacaccattggatatcttattgaagaaaatgagtattgacaagaaaaacgagggttccaaaaagaaggtggtcattttagaaagtattggtaagtgctatggtgactccgctcaatttgttagcgatgaagacctgagatttattctaacagatgaaaccctcgtttaccccttcaaggacatccctgctgatcaacagaaagttgttatcccccctggttctaagtccatctccaatcgtgctttaattcttgctgccctcggtgaaggtcaatgtaaaatcaagaacttattacattctgatgatactaaacatatgttaaccgctgttcatgaattgaaaggtgctacgatatcatgggaagataatggtgagacggtagtggtggaaggacatggtggttccacattgtcagcttgtgctgaccccttatatctaggtaatgcaggtactgcatctagatttttgacttccttggctgccttggtcaattctacttcaagccaaaagtatatcgttttaactggtaacgcaagaatgcaacaaagaccaattgctcctttggtcgattctttgcgtgctaatggtactaaaattgagtacttgaataatgaaggttccctgccaatcaaagtttatactgattcggtattcaaaggtggtagaattgaattagctgctacagtttcttctcagtacgtatcctctatcttgatgtgtgccccatacgctgaagaacctgtaactttggctcttgttggtggtaagccaatctctaaattgtacgtcgatatgacaataaaaatgatggaaaaattcggtatcaatgttgaaacttctactacagaaccttacacttattatattccaaagggacattatattaacccatcagaatacgtcattgaaagtgatgcctcaagtgctacatacccattggccttcgccgcaatgactggtactaccgtaacggttccaaacattggttttgagtcgttacaaggtgatgccagatttgcaagagatgtcttgaaacctatgggttgtaaaataactcaaacggcaacttcaactactgtttcgggtcctcctgtaggtactttaaagccattaaaacatgttgatatggagccaatgactgatgcgttcttaactgcatgtgttgttgccgctatttcgcacgacagtgatccaaattctgcaaatacaaccaccattgaaggtattgcaaaccagcgtgtcaaagagtgtaacagaattttggccatggctacagagctcgccaaatttggcgtcaaaactacagaattaccagatggtattcaagtccatggtttaaactcgataaaagatttgaaggttccttccgactcttctggacctgtcggtgtatgcacatatgatgatcatcgtgtggccatgagtttctcgcttcttgcaggaatggtaaattctcaaaatgaacgtgacgaagttgctaatcctgtaagaatacttgaaagacattgtactggtaaaacctggcctggctggtgggatgtgttacattccgaactaggtgccaaattagatggtgcagaacctttagagtgcacatccaaaaagaactcaaagaaaagcgttgtcattattggcatgagagcagctggcaaaactactataagtaaatggtgcgcatccgctctgggttacaaattagttgacctagacgagctgtttgagcaacagcataacaatcaaagtgttaaacaatttgttgtggagaacggttgggagaagttccgtgaggaagaaacaagaattttcaaggaagttattcaaaattacggcgatgatggatatgttttctcaacaggtggcggtattgttgaaagcgctgagtctagaaaagccttaaaagattttgcctcatcaggtggatacgttttacacttacatagggatattgaggagacaattgtctttttacaaagtgatccttcaagacctgcctatgtggaagaaattcgtgaagtttggaacagaagggaggggtggtataaagaatgctcaaatttctctttctttgctcctcattgctccgcagaagctgagttccaagctctaagaagatcgtttagtaagtacattgcaaccattacaggtgtcagagaaatagaaattccaagcggaagatctgcctttgtgtgtttaacctttgatgacttaactgaacaaactgagaatttgactccaatctgttatggttgtgaggctgtagaggtcagagtagaccatttggctaattactctgctgatttcgtgagtaaacagttatctatattgcgtaaagccactgacagtattcctatcatttttactgtgcgaaccatgaagcaaggtggcaactttcctgatgaagagttcaaaaccttgagagagctatacgatattgccttgaagaatggtgttgaattccttgacttagaactaactttacctactgatatccaatatgaggttattaacaaaaggggcaacaccaagatcattggttcccatcatgacttccaaggattatactcctgggacgacgctgaatgggaaaacagattcaatcaagcgttaactcttgatgtggatgttgtaaaatttgtgggtacggctgttaatttcgaagataatttgagactggaacactttagggatacacacaagaataagcctttaattgcagttaatatgacttctaaaggtagcatttctcgtgttttgaataatgttttaacacctgtgacatcagatttattgcctaactccgctgcccctggccaattgacagtagcacaaattaacaagatgtatacatctatgggaggttga

SEQ ID NO: 2 - protein, 1303 aa, Saccharomyces cerevisiae
MVQLAKVPILGNDIIHVGYNIHDHLVETIIKHCPSSTYVICNDTNLSKVPYYQQLVLEFKASLPEGSRLLTYVVKPGETSKSRETKAQLEDYLLVEGCTRDTVMVAIGGGVIGDMIGFVASTFMRGVRVVQVPTSLLAMVDSSIGGKTAIDTPLGKNFIGAFWQPKFVLVDIKWLETLAKREFINGMAEVIKTACIWNADEFTRLESNASLFLNVVNGAKNVKVTNQLTNEIDEISNTDIEAMLDHTYKLVLESIKVKAEVVSSDERESSLRNLLNFGHSIGHAYEAILTPQALHGECVSIGMVKEAELSRYFGILSPTQVARLSKILVAYGLPVSPDEKWFKELTLHKKTPLDILLKKMSIDKKNEGSKKKVVILESIGKCYGDSAQFVSDEDLRFILTDETLVYPFKDIPADQQKVVIPPGSKSISNRALILAALGEGQCKIKNLLHSDDTKHMLTAVHELKGATISWEDNGETVVVEGHGGSTLSACADPLYLGNAGTASRFLTSLAALVNSTSSQKYIVLTGNARMQQRPIAPLVDSLRANGTKIEYLNNEGSLPIKVYTDSVFKGGRIELAATVSSQYVSSILMCAPYAEEPVTLALVGGKPISKLYVDMTIKMMEKFGINVETSTTEPYTYYIPKGHYINPSEYVIESDASSATYPLAFAAMTGTTVTVPNIGFESLQGDARFARDVLKPMGCKITQTATSTTVSGPPVGTLKPLKHVDMEPMTDAFLTACVVAAISHDSDPNSANTTTIEGIANQRVKECNRILAMATELAKFGVKTTELPDGIQVHGLNSIKDLKVPSDSSGPVGVCTYDDHRVAMSFSLLAGMVNSQNERDEVANPVRILERHCTGKTWPGWWDVLHSELGAKLDGAEPLECTSKKNSKKSVVIIGMRAAGKTTISKWCASALGYKLVDLDELFEQQHNNQSVKQFVVENGWEKFREEETRIFKEVIQNYGDDGYVFSTGGGIVESAESRKALKDFASSGGYVLHLHRDIEETIVFLQSDPSRPAYVEEIREVWNRREGWYKECSNFSFFAPHCSAEAEFQALRRSFSKYIATITGVREIEIPSGRSAFVCLTFDDLTEQTENLTPICYGCEAVEVRVDHLANYSADFVSKQLSILRKATDSIPIIFTVRTMKQGGNFPDEEFKTLRELYDIALKNGVEFLDLELTLPTDIQYEVINKRGNTKIIGSHHDFQGLYSWDDAEWENRFNQALTLDVDVVKFVGTAVNFEDNLRLEHFRDTHKNKPLIAVNMTSKGSISRVLNNVLTPVTSDLLPNSAAPGQLTVAQINKMYTSMGG

SEQ ID NO: 3 - DNA, 4767 bp, Saccharomyces cerevisiae
atggtgcagttagccaaagtcccaattctaggaaatgatattatccacgttgggtataacattcatgaccatttggttgaaaccataattaaacattgtccttcttcgacatacgttatttgcaatgatacgaacttgagtaaagttccatactaccagcaattagtcctggaattcaaggcttctttgccagaaggctctcgtttacttacttatgttgttaaaccaggtgagacaagtaaaagtagagaaaccaaagcgcagctagaagattatcttttagtggaaggatgtactcgtgatacggttatggtagcgatcggtggtggtgttattggtgacatgattgggttcgttgcatctacatttatgagaggtgttcgtgttgtccaagtaccaacatccttattggcaatggtcgattcctccattggtggtaaaactgctattgacactcctctaggtaaaaactttattggtgcattttggcaaccaaaatttgtccttgtagatattaaatggctagaaacgttagccaagagagagtttatcaatgggatggcagaagttatcaagactgcttgtatttggaacgctgacgaatttactagattagaatcaaacgcttcgttgttcttaaatgttgttaatggggcaaaaaatgtcaaggttaccaatcaattgacaaacgagattgacgagatatcgaatacagatattgaagctatgttggatcatacatataagttagttcttgagagtattaaggtcaaagcggaagttgtctcttcggatgaacgtgaatccagtctaagaaaccttttgaacttcggacattctattggtcatgcttatgaagctatactaaccccacaagcattacatggtgaatgtgtgtccattggtatggttaaagaggcggaattatcccgttatttcggtattctctcccctacccaagttgcacgtctatccaagattttggttgcctacgggttgcctgtttcgcctgatgagaaatggtttaaagagctaaccttacataagaaaacaccattggatatcttattgaagaaaatgagtattgacaagaaaaacgagggttccaaaaagaaggtggtcattttagaaagtattggtaagtgctatggtgactccgctcaatttgttagcgatgaagacctgagatttattctaacagatgaaaccctcgtttaccccttcaaggacatccctgctgatcaacagaaagttgttatcccccctggttctaagtccatctccaatcgtgctttaattcttgctgccctcggtgaaggtcaatgtaaaatcaagaacttattacattctgatgatactaaacatatgttaaccgctgttcatgaattgaaaggtgctacgatatcatgggaagataatggtgagacggtagtggtggaaggacatggtggttccacattgtcagcttgtgctgaccccttatatctaggtaatgcaggtactgcatctagatttttgacttccttggctgccttggtcaattctacttcaagccaaaagtatatcgttttaactggtaacgcaagaatgcaacaaagaccaattgctcctttggtcgattctttgcgtgctaatggtactaaaattgagtacttgaataatgaaggttccctgccaatcaaagtttatactgattcggtattcaaaggtggtagaattgaattagctgctacagtttcttctcagtacgtatcctctatcttgatgtgtgccccatacgctgaagaacctgtaactttggctcttgttggtggtaagccaatctctaaattgtacgtcgatatgacaataaaaatgatggaaaaattcggtatcaatgttgaaacttctactacagaaccttacacttattatattccaaagggacattatattaacccatcagaatacgtcattgaaagtgatgcctcaagtgctacatacccattggccttcgccgcaatgactggtactaccgtaacggttccaaacattggttttgagtcgttacaaggtgatgccagatttgcaagagatgtcttgaaacctatgggttgtaaaataactcaaacggcaacttcaactactgtttcgggtcctcctgtaggtactttaaagccattaaaacatgttgatatggagccaatgactgatgcgttcttaactgcatgtgttgttgccgctatttcgcacgacagtgatccaaattctgcaaatacaaccaccattgaaggtattgcaaaccagcgtgtcaaagagtgtaacagaattttggccatggctacagagctcgccaaatttggcgtcaaaactacagaattaccagatggtattcaagtccatggtttaaactcgataaaagatttgaaggttccttccgactcttctggacctgtcggtgtatgcacatatgatgatcatcgtgtggccatgagtttctcgcttcttgcaggaatggtaaattctcaaaatgaacgtgacgaagttgctaatcctgtaagaatacttgaaagacattgtactggtaaaacctggcctggctggtgggatgtgttacattccgaactaggtgccaaattagatggtgcagaacctttagagtgcacatccaaaaagaactcaaagaaaagcgttgtcattattggcatgagagcagctggcaaaactactataagtaaatggtgcgcatccgctctgggttacaaattagttgacctagacgagctgtttgagcaacagcataacaatcaaagtgttaaacaatttgttgtggagaacggttgggagaagttccgtgaggaagaaacaagaattttcaaggaagttattcaaaattacggcgatgatggatatgttttctcaacaggtggcggtattgttgaaagcgctgagtctagaaaagccttaaaagattttgcctcatcaggtggatacgttttacacttacatagggatattgaggagacaattgtctttttacaaagtgatccttcaagacctgcctatgtggaagaaattcgtgaagtttggaacagaagggaggggtggtataaagaatgctcaaatttctctttctttgctcctcattgctccgcagaagctgagttccaagctctaagaagatcgtttagtaagtacattgcaaccattacaggtgtcagagaaatagaaattccaagcggaagatctgcctttgtgtgtttaacctttgatgacttaactgaacaaactgagaatttgactccaatctgttatggttgtgaggctgtagaggtcagagtagaccatttggctaattactctgctgatttcgtgagtaaacagttatctatattgcgtaaagccactgacagtattcctatcatttttactgtgcgaaccatgaagcaaggtggcaactttcctgatgaagagttcaaaaccttgagagagctatacgatattgccttgaagaatggtgttgaattccttgacttagaactaactttacctactgatatccaatatgaggttattaacaaaaggggcaacaccaagatcattggttcccatcatgacttccaaggattatactcctgggacgacgctgaatgggaaaacagattcaatcaagcgttaactcttgatgtggatgttgtaaaatttgtgggtacggctgttaatttcgaagataatttgagactggaacactttagggatacacacaagaataagcctttaattgcagttaatatgacttctaaaggtagcatttctcgtgttttgaataatgttttaacacctgtgacatcagatttattgcctaactccgctgcccctggccaattgacagtagcacaaattaacaagatgtatacatctatgggaggtatcgagcctaaggaactgtttgttgttggaaagccaattggccactctagatcgccaattttacataacactggctatgaaattttaggtttacctcacaagttcgataaatttgaaactgaatccgcacaattggtgaaagaaaaacttttggacggaaacaagaactttggcggtgctgcagtcacaattcctctgaaattagatataatgcagtacatggatgaattgactgatgctgctaaagttattggtgctgtaaacacagttataccattgggtaacaagaagtttaagggtgataataccgactggttaggtatccgtaatgccttaattaacaatggcgttcccgaatatgttggtcataccgctggtttggttatcggtgcaggtggcacttctagagccgccctttacgccttgcacagtttaggttgcaaaaagatcttcataatcaacaggacaacttcgaaattgaagccattaatagagtcacttccatctgaattcaacattattggaatagagtccactaaatctatagaagagattaaggaacacgttggcgttgctgtcagctgtgtaccagccgacaaaccattagatgacgaacttttaagtaagctggagagattccttgtgaaaggtgcccatgctgcttttgtaccaaccttattggaagccgcatacaaaccaagcgttactcccgttatgacaatttcacaagacaaatatcaatggcacgttgtccctggatcacaaatgttagtacaccaaggtgtagctcagtttgaaaagtggacaggattcaagggccctttcaaggccatttttgatgccgttacgaaagagtag

SEQ ID NO: 4 - protein, 1588 aa, Saccharomyces cerevisiae
MVQLAKVPILGNDIIHVGYNIHDHLVETIIKHCPSSTYVICNDTNLSKVPYYQQLVLEFKASLPEGSRLLTYVVKPGETSKSRETKAQLEDYLLVEGCTRDTVMVAIGGGVIGDMIGFVASTFMRGVRVVQVPTSLLAMVDSSIGGKTAIDTPLGKNFIGAFWQPKFVLVDIKWLETLAKREFINGMAEVIKTACIWNADEFTRLESNASLFLNVVNGAKNVKVTNQLTNEIDEISNTDIEAMLDHTYKLVLESIKVKAEVVSSDERESSLRNLLNFGHSIGHAYEAILTPQALHGECVSIGMVKEAELSRYFGILSPTQVARLSKILVAYGLPVSPDEKWFKELTLHKKTPLDILLKKMSIDKKNEGSKKKVVILESIGKCYGDSAQFVSDEDLRFILTDETLVYPFKDIPADQQKVVIPPGSKSISNRALILAALGEGQCKIKNLLHSDDTKHMLTAVHELKGATISWEDNGETVVVEGHGGSTLSACADPLYLGNAGTASRFLTSLAALVNSTSSQKYIVLTGNARMQQRPIAPLVDSLRANGTKIEYLNNEGSLPIKVYTDSVFKGGRIELAATVSSQYVSSILMCAPYAEEPVTLALVGGKPISKLYVDMTIKMMEKFGINVETSTTEPYTYYIPKGHYINPSEYVIESDASSATYPLAFAAMTGTTVTVPNIGFESLQGDARFARDVLKPMGCKITQTATSTTVSGPPVGTLKPLKHVDMEPMTDAFLTACVVAAISHDSDPNSANTTTIEGIANQRVKECNRILAMATELAKFGVKTTELPDGIQVHGLNSIKDLKVPSDSSGPVGVCTYDDHRVAMSFSLLAGMVNSQNERDEVANPVRILERHCTGKTWPGWWDVLHSELGAKLDGAEPLECTSKKNSKKSVVIIGMRAAGKTTISKWCASALGYKLVDLDELFEQQHNNQSVKQFVVENGWEKFREEETRIFKEVIQNYGDDGYVFSTGGGIVESAESRKALKDFASSGGYVLHLHRDIEETIVFLQSDPSRPAYVEEIREVWNRREGWYKECSNFSFFAPHCSAEAEFQALRRSFSKYIATITGVREIEIPSGRSAFVCLTFDDLTEQTENLTPICYGCEAVEVRVDHLANYSADFVSKQLSILRKATDSIPIIFTVRTMKQGGNFPDEEFKTLRELYDIALKNGVEFLDLELTLPTDIQYEVINKRGNTKIIGSHHDFQGLYSWDDAEWENRFNQALTLDVDVVKFVGTAVNFEDNLRLEHFRDTHKNKPLIAVNMTSKGSISRVLNNVLTPVTSDLLPNSAAPGQLTVAQINKMYTSMGGIEPKELFVVGKPIGHSRSPILHNTGYEILGLPHKFDKFETESAQLVKEKLLDGNKNFGGAAVTIPLKLDIMQYMDELTDAAKVIGAVNTVIPLGNKKFKGDNTDWLGIRNALINNGVPEYVGHTAGLVIGAGGTSRAALYALHSLGCKKIFIINRTTSKLKPLIESLPSEFNIIGIESTKSIEEIKEHVGVAVSCVPADKPLDDELLSKLERFLVKGAHAAFVPTLLEAAYKPSVTPVMTISQDKYQWHVVPGSQMLVHQGVAQFEKWTGFKGPFKAIFDAVTKE

SEQ ID NO: 5 - DNA, 4767 bp, Artificial Sequence
  Synthetic oligonucleotide
atggtgcagttagccaaagtcccaattctaggaaatgatattatccacgttgggtataacattcatgaccatttggttgaaaccataattaaacattgtccttcttcgacatacgttatttgcaatgatacgaacttgagtaaagttccatactaccagcaattagtcctggaattcaaggcttctttgccagaaggctctcgtttacttacttatgttgttaaaccaggtgagacaagtaaaagtagagaaaccaaagcgcagctagaagattatcttttagtggaaggatgtactcgtgatacggttatggtagcgatcggtggtggtgttattggtgacatgattgggttcgttgcatctacatttatgagaggtgttcgtgttgtccaagtaccaacatccttattggcaatggtcgattcctccattggtggtaaaactgctattgacactcctctaggtaaaaactttattggtgcattttggcaaccaaaatttgtccttgtagatattaaatggctagaaacgttagccaagagagagtttatcaatgggatggcagaagttatcaagactgcttgtatttggaacgctgacgaatttactagattagaatcaaacgcttcgttgttcttaaatgttgttaatggggcaaaaaatgtcaaggttaccaatcaattgacaaacgagattgacgagatatcgaatacagatattgaagctatgttggatcatacatataagttagttcttgagagtattaaggtcaaagcggaagttgtctcttcggatgaacgtgaatccagtctaagaaaccttttgaacttcggacattctattggtcatgcttatgaagctatactaaccccacaagcattacatggtgaatgtgtgtccattggtatggttaaagaggcggaattatcccgttatttcggtattctctcccctacccaagttgcacgtctatccaagattttggttgcctacgggttgcctgtttcgcctgatgagaaatggtttaaagagctaaccttacataagaaaacaccattggatatcttattgaagaaaatgagtattgacaagaaaaacgagggttccaaaaagaaggtggtcattttagaaagtattggtaagtgctatggtgactccgctcaatttgttagcgatgaagacctgagatttattctaacagatgaaaccctcgtttaccccttcaaggacatccctgctgatcaacagaaagttgttatcccccctggttctaagtccatctccaatcgtgctttaattcttgctgccctcggtgaaggtcaatgtaaaatcaagaacttattacattctgatgatactaaacatatgttaaccgctgttcatgaattgaaaggtgctacgatatcatgggaagataatggtgagacggtagtggtggaaggacatggtggttccacattgtcagcttgtgctgaccccttatatctaggtaatgcaggtactgcatctagatttttgacttccttggctgccttggtcaattctacttcaagccaaaagtatatcgttttaactggtaacgcaagaatgcaacaaagaccaattgctcctttggtcgattctttgcgtgctaatggtactaaaattgagtacttgaataatgaaggttccctgccaatcaaagtttatactgattcggtattcaaaggtggtagaattgaattagctgctacagtttcttctcagtacgtatcctctatcttgatgtgtgccccatacgctgaagaacctgtaactttggctcttgttggtggtaagccaatctctaaattgtacgtcgatatgacaataaaaatgatggaaaaattcggtatcaatgttgaaacttctactacagaaccttacacttattatattccaaagggacattatattaacccatcagaatacgtcattgaaagtgatgcctcaagtgctacatacccattggccttcgccgcaatgactggtactaccgtaacggttccaaacattggttttgagtcgttacaaggtgatgccagatttgcaagagatgtcttgaaacctatgggttgtaaaataactcaaacggcaacttcaactactgtttcgggtcctcctgtaggtactttaaagccattaaaacatgttgatatggagccaatgactgatgcgttcttaactgcatgtgttgttgccgctatttcgcacgacagtgatccaaattctgcaaatacaaccaccattgaaggtattgcaaaccagcgtgtcaaagagtgtaacagaattttggccatggctacagagctcgccaaatttggcgtcaaaactacagaattaccagatggtattcaagtccatggtttaaactcgataaaagatttgaaggttccttccgactcttctggacctgtcggtgtatgcacatatgatgatcatcgtgtggccatgagtttctcgcttcttgcaggaatggtaaattctcaaaatgaacgtgacgaagttgctaatcctgtaagaatacttgaaagacattgtactggtaaaacctggcctggctggtgggatgtgttacattccgaactaggtgccaaattagatggtgcagaacctttagagtgcacatccaaaaagaactcaaagaaaagcgttgtcattattggcatgagagcagctggcaaaactactataagtaaatggtgcgcatccgctctgggttacaaattagttgacctagacgagctgtttgagcaacagcataacaatcaaagtgttaaacaatttgttgtggagaacggttgggagaagttccgtgaggaagaaacaagaattttcaaggaagttattcaaaattacggcgatgatggatatgttttctcaacaggtggcggtattgttgaaagcgctgagtctagaaaagccttaaaagattttgcctcatcaggtggatacgttttacacttacatagggatattgaggagacaattgtctttttacaaagtgatccttcaagacctgcctatgtggaagaaattcgtgaagtttggaacagaagggaggggtggtataaagaatgctcaaatttctctttctttgctcctcattgctccgcagaagctgagttccaagctctaagaagatcgtttagtaagtacattgcaaccattacaggtgtcagagaaatagaaattccaagcggaagatctgcctttgtgtgtttaacctttgatgacttaactgaacaaactgagaatttgactccaatctgttatggttgtgaggctgtagaggtcagagtagaccatttggctaattactctgctgatttcgtgagtaaacagttatctatattgcgtaaagccactgacagtattcctatcatttttactgtgcgaaccatgaagcaaggtggcaactttcctgatgaagagttcaaaaccttgagagagctatacgatattgccttgaagaatggtgttgaattccttgacttagaactaactttacctactgatatccaatatgaggttattaacaaaaggggcaacaccaagatcattggttcccatcatgacttccaaggattatactcctgggacgacgctgaatgggaaaacagattcaatcaagcgttaactcttgatgtggatgttgtaaaatttgtgggtacggctgttaatttcgaagataatttgagactggaacactttagggatacacacaagaataagcctttaattgcagttaatatgacttctaaaggtagcatttctcgtgttttgaataatgttttaacacctgtgacatcagatttattgcctaactccgctgcccctggccaattgacagtagcacaaattaacaagatgtatacatctatgggaggtatcgagcctaaggaactgtttgttgttggaaagccaattggccactctagatcgccaattttacataacactggctatgaaattttaggtttacctcacaagttcgataaatttgaaactgaatccgcacaattggtgaaagaaaaacttttggacggaaacaagaactttggcggtgctgcagtcacaattcctctgaaattagatataatgcagtacatggatgaattgactgatgctgctaaagttattggtgctgtaaacacagttataccattgggtaacaagaagtttaagggtgataataccgactggttaggtatccgtaatgccttaattaacaatggcgttcccgaatatgttggtcataccgctggtttggttatcggtgcaggtggcacttctagagccgccctttacgccttgcacagtttaggttgcaaaaagatcttcataatcaacaggacaacttcgaaattgaagccattaatagagtcacttccatctgaattcaacattattggaatagagtccactaaatctatagaagagattaaggaacacgttggcgttgctgtcagctgtgtaaaagccgacaaaccattagatgacgaacttttaagtaagctggagagattccttgtgaaaggtgcccatgctgcttttgtaccaaccttattggaagccgcatacaaaccaagcgttactcccgttatgacaatttcacaagacaaatatcaatggcacgttgtccctggatcacaaatgttagtacaccaaggtgtagctcagtttgaaaagtggacaggattcaagggccctttcaaggccatttttgatgccgttacgaaagagtag

SEQ ID NO: 6 - DNA, 5064 bp, Artificial Sequence
  Synthetic oligonucleotide
atggtgcagttagccaaagtcccaattctaggaaatgatattatccacgttgggtataacattcatgaccatttggttgaaaccataattaaacattgtccttcttcgacatacgttatttgcaatgatacgaacttgagtaaagttccatactaccagcaattagtcctggaattcaaggcttctttgccagaaggctctcgtttacttacttatgttgttaaaccaggtgagacaagtaaaagtagagaaaccaaagcgcagctagaagattatcttttagtggaaggatgtactcgtgatacggttatggtagcgatcggtggtggtgttattggtgacatgattgggttcgttgcatctacatttatgagaggtgttcgtgttgtccaagtaccaacatccttattggcaatggtcgattcctccattggtggtaaaactgctattgacactcctctaggtaaaaactttattggtgcattttggcaaccaaaatttgtccttgtagatattaaatggctagaaacgttagccaagagagagtttatcaatgggatggcagaagttatcaagactgcttgtatttggaacgctgacgaatttactagattagaatcaaacgcttcgttgttcttaaatgttgttaatggggcaaaaaatgtcaaggttaccaatcaattgacaaacgagattgacgagatatcgaatacagatattgaagctatgttggatcatacatataagttagttcttgagagtattaaggtcaaagcggaagttgtctcttcggatgaacgtgaatccagtctaagaaaccttttgaacttcggacattctattggtcatgcttatgaagctatactaaccccacaagcattacatggtgaatgtgtgtccattggtatggttaaagaggcggaattatcccgttatttcggtattctctcccctacccaagttgcacgtctatccaagattttggttgcctacgggttgcctgtttcgcctgatgagaaatggtttaaagagctaaccttacataagaaaacaccattggatatcttattgaagaaaatgagtattgacaagaaaaacgagggttccaaaaagaaggtggtcattttagaaagtattggtaagtgctatggtgactccgctcaatttgttagcgatgaagacctgagatttattctaacagatgaaaccctcgtttaccccttcaaggacatccctgctgatcaacagaaagttgttatcccccctggttctaagtccatctccaatcgtgctttaattcttgctgccctcggtgaaggtcaatgtaaaatcaagaacttattacattctgatgatactaaacatatgttaaccgctgttcatgaattgaaaggtgctacgatatcatgggaagataatggtgagacggtagtggtggaaggacatggtggttccacattgtcagcttgtgctgaccccttatatctaggtaatgcaggtactgcatctagatttttgacttccttggctgccttggtcaattctacttcaagccaaaagtatatcgttttaactggtaacgcaagaatgcaacaaagaccaattgctcctttggtcgattctttgcgtgctaatggtactaaaattgagtacttgaataatgaaggttccctgccaatcaaagtttatactgattcggtattcaaaggtggtagaattgaattagctgctacagtttcttctcagtacgtatcctctatcttgatgtgtgccccatacgctgaagaacctgtaactttggctcttgttggtggtaagccaatctctaaattgtacgtcgatatgacaataaaaatgatggaaaaattcggtatcaatgttgaaacttctactacagaaccttacacttattatattccaaagggacattatattaacccatcagaatacgtcattgaaagtgatgcctcaagtgctacatacccattggccttcgccgcaatgactggtactaccgtaacggttccaaacattggttttgagtcgttacaaggtgatgccagatttgcaagagatgtcttgaaacctatgggttgtaaaataactcaaacggcaacttcaactactgtttcgggtcctcctgtaggtactttaaagccattaaaacatgttgatatggagccaatgactgatgcgttcttaactgcatgtgttgttgccgctatttcgcacgacagtgatccaaattctgcaaatacaaccaccattgaaggtattgcaaaccagcgtgtcaaagagtgtaacagaattttggccatggctacagagctcgccaaatttggcgtcaaaactacagaattaccagatggtattcaagtccatggtttaaactcgataaaagatttgaaggttccttccgactcttctggacctgtcggtgtatgcacatatgatgatcatcgtgtggccatgagtttctcgcttcttgcaggaatggtaaattctcaaaatgaacgtgacgaagttgctaatcctgtaagaatacttgaaagacattgtactggtaaaacctggcctggctggtgggatgtgttacattccgaactaggtgccaaattagatggtgcagaacctttagagtgcacatccaaaaagaactcaaagaaaagcgttgtcattattggcatgagagcagctggcaaaactactataagtaaatggtgcgcatccgctctgggttacaaattagttgacctagacgagctgtttgagcaacagcataacaatcaaagtgttaaacaatttgttgtggagaacggttgggagaagttccgtgaggaagaaacaagaattttcaaggaagttattcaaaattacggcgatgatggatatgttttctcaacaggtggcggtattgttgaaagcgctgagtctagaaaagccttaaaagattttgcctcatcaggtggatacgttttacacttacatagggatattgaggagacaattgtctttttacaaagtgatccttcaagacctgcctatgtggaagaaattcgtgaagtttggaacagaagggaggggtggtataaagaatgctcaaatttctctttctttgctcctcattgctccgcagaagctgagttccaagctctaagaagatcgtttagtaagtacattgcaaccattacaggtgtcagagaaatagaaattccaagcggaagatctgcctttgtgtgtttaacctttgatgacttaactgaacaaactgagaatttgactccaatctgttatggttgtgaggctgtagaggtcagagtagaccatttggctaattactctgctgatttcgtgagtaaacagttatctatattgcgtaaagccactgacagtattcctatcatttttactgtgcgaaccatgaagcaaggtggcaactttcctgatgaagagttcaaaaccttgagagagctatacgatattgccttgaagaatggtgttgaattccttgacttagaactaactttacctactgatatccaatatgaggttattaacaaaaggggcaacaccaagatcattggttcccatcatgacttccaaggattatactcctgggacgacgctgaatgggaaaacagattcaatcaagcgttaactcttgatgtggatgttgtaaaatttgtgggtacggctgttaatttcgaagataatttgagactggaacactttagggatacacacaagaataagcctttaattgcagttaatatgacttctaaaggtagcatttctcgtgttttgaataatgttttaacacctgtgacatcagatttattgcctaactccgctgcccctggccaattgacagtagcacaaattaacaagatgtatacatctatgggaggtatcgagcctaaggaactgtttgttgttggaaagccaattggccccgggaaaatgccttccaaactcgccatcacttccatgtcacttggccggtgttatgccggccactccttcaccactaagctcgatatggcccggaaatatggctatcaaggcctagagctcttccacgaggacttggctgatgtagcctatcgtctctccggagagaccccttccccatgtggcccgtccccagcagcccagctctcggctgcccgtcaaatcctccgcatgtgccaagtcagaaacattgaaatcgtctgcctccagcccttcagccagtacgacggcctactcgaccgcgaggagcacgagcgccgtctggagcagctcgagttctggatcgagctcgcccacgagcttgacacagacattatccaaatccccgccaactttctccccgccgaggaagtaactgaggacatttcgctcatcgtctcggaccttcaagaagtggccgacatgggcctgcaggccaacccacccatccgctttgtctacgaggctctgtgctggagcactcgtgtcgacacttgggagcgtagctgggaggtggtgcagagggtgaacaggcccaactttggcgtgtgcctggacactttcaacattgcggggcgggtatatgctgatccgacggttgcctctggccgcacccccaacgcggaggaagcgatacggaagtcgattgcgcgtctcgttgaaagggtcgatgtcagcaaggtcttttatgtgcaggttgtggacgctgagaagttgaagaagccgctggtgccgggtcatcggttttatgacccggagcagccggcgaggatgagctggtcaaggaactgcaggttattctacggggagaaggacagaggggcgtatttgcccgtcaaggagattgcctgggccttcttcaacgggctcggattcgagggttgggtcagtctggagctcttcaacagaagaatgtcggacacaggctttggggtgcccgaggagctggccaggagaggggccgtgtcgtgggcaaagctggtgagggacatgaagatcactgttgattcaccaacacaacaacaagccacacagcagcccatcaggatgctgtcgctgtcagcggctttgtaa

SEQ ID NO: 7 - protein, 1687 aa, Artificial Sequence
  Synthetic polypeptide
MVQLAKVPILGNDIIHVGYNIHDHLVETIIKHCPSSTYVICNDTNLSKVPYYQQLVLEFKASLPEGSRLLTYVVKPGETSKSRETKAQLEDYLLVEGCTRDTVMVAIGGGVIGDMIGFVASTFMRGVRVVQVPTSLLAMVDSSIGGKTAIDTPLGKNFIGAFWQPKFVLVDIKWLETLAKREFINGMAEVIKTACIWNADEFTRLESNASLFLNVVNGAKNVKVTNQLTNEIDEISNTDIEAMLDHTYKLVLESIKVKAEVVSSDERESSLRNLLNFGHSIGHAYEAILTPQALHGECVSIGMVKEAELSRYFGILSPTQVARLSKILVAYGLPVSPDEKWFKELTLHKKTPLDILLKKMSIDKKNEGSKKKVVILESIGKCYGDSAQFVSDEDLRFILTDETLVYPFKDIPADQQKVVIPPGSKSISNRALILAALGEGQCKIKNLLHSDDTKHMLTAVHELKGATISWEDNGETVVVEGHGGSTLSACADPLYLGNAGTASRFLTSLAALVNSTSSQKYIVLTGNARMQQRPIAPLVDSLRANGTKIEYLNNEGSLPIKVYTDSVFKGGRIELAATVSSQYVSSILMCAPYAEEPVTLALVGGKPISKLYVDMTIKMMEKFGINVETSTTEPYTYYIPKGHYINPSEYVIESDASSATYPLAFAAMTGTTVTVPNIGFESLQGDARFARDVLKPMGCKITQTATSTTVSGPPVGTLKPLKHVDMEPMTDAFLTACVVAAISHDSDPNSANTTTIEGIANQRVKECNRILAMATELAKFGVKTTELPDGIQVHGLNSIKDLKVPSDSSGPVGVCTYDDHRVAMSFSLLAGMVNSQNERDEVANPVRILERHCTGKTWPGWWDVLHSELGAKLDGAEPLECTSKKNSKKSVVIIGMRAAGKTTISKWCASALGYKLVDLDELFEQQHNNQSVKQFVVENGWEKFREEETRIFKEVIQNYGDDGYVFSTGGGIVESAESRKALKDFASSGGYVLHLHRDIEETIVFLQSDPSRPAYVEEIREVWNRREGWYKECSNFSFFAPHCSAEAEFQALRRSFSKYIATITGVREIEIPSGRSAFVCLTFDDLTEQTENLTPICYGCEAVEVRVDHLANYSADFVSKQLSILRKATDSIPIIFTVRTMKQGGNFPDEEFKTLRELYDIALKNGVEFLDLELTLPTDIQYEVINKRGNTKIIGSHHDFQGLYSWDDAEWENRFNQALTLDVDVVKFVGTAVNFEDNLRLEHFRDTHKNKPLIAVNMTSKGSISRVLNNVLTPVTSDLLPNSAAPGQLTVAQINKMYTSMGGIEPKELFVVGKPIGPGKMPSKLAITSMSLGRCYAGHSFTTKLDMARKYGYQGLELFHEDLADVAYRLSGETPSPCGPSPAAQLSAARQILRMCQVRNIEIVCLQPFSQYDGLLDREEHERRLEQLEFWIELAHELDTDIIQIPANFLPAEEVTEDISLIVSDLQEVADMGLQANPPIRFVYEALCWSTRVDTWERSWEVVQRVNRPNFGVCLDTFNIAGRVYADPTVASGRTPNAEEAIRKSIARLVERVDVSKVFYVQVVDAEKLKKPLVPGHRFYDPEQPARMSWSRNCRLFYGEKDRGAYLPVKEIAWAFFNGLGFEGWVSLELFNRRMSDTGFGVPEELARRGAVSWAKLVRDMKITVDSPTQQQATQQPIRMLSLSAAL

SEQ ID NO: 8 - protein, 221 aa, Homo sapiens
MGDTKEQRILNHVLQHAEPGNAQSVLEAIDTYCEQKEWAMNVGDKKGKIVDAVIQEHQPSVLLELGAYCGYSAVRMARLLSPGARLITIEINPDCAAITQRMVDFAGVKDKVTLVVGASQDIIPQLKKKYDVDTLDMVFLDHWKDRYLPDTLLLEECGLLRKGTVLLADNVICPGAPDFLAHVRGSSCFECTHYQSFLEYREVVDGLEKAIYKGPGSEAGP

SEQ ID NO: 9 - protein, 363 aa, Arabidopsis thaliana
MGSTAETQLTPVQVTDDEAALFAMQLASASVLPMALKSALELDLLEIMAKNGSPMSPTEIASKLPTKNPEAPVMLDRILRLLTSYSVLTCSNRKLSGDGVERIYGLGPVCKYLTKNEDGVSIAALCLMNQDKVLMESWYHLKDAILDGGIPFNKAYGMSAFEYHGTDPRFNKVFNNGMSNHSTITMKKILETYKGFEGLTSLVDVGGGIGATLKMIVSKYPNLKGINFDLPHVIEDAPSHPGIEHVGGDMFVSVPKGDAIFMKWICHDWSDEHCVKFLKNCYESLPEDGKVILAECILPETPDSSLSTKQVVHVDCIMLAHNPGGKERTEKEFEALAKASGFKGIKVVCDAFGVNLIELLKKL

SEQ ID NO: 10 - protein, 365 aa, Fragaria x ananassa
MGSTGETQMTPTHVSDEEANLFAMQLASASVLPMVLKAAIELDLLEIMAKAGPGSFLSPSDLASQLPTKNPEAPVMLDRMLRLLASYSILTCSLRTLPDGKVERLYCLGPVCKFLTKNEDGVSIAALCLMNQDKVLVESWYHLKDAVLDGGIPFNKAYGMTAFDYHGTDPRFNKVFNKGMADHSTITMKKILETYKGFEGLKSIVDVGGGTGAVVNMIVSKYPSIKGINFDLPHVIEDAPQYPGVQHVGGDMFVSVPKGNAIFMKWICHDWSDEHCIKFLKNCYAALPDDGKVILAECILPVAPDTSLATKGVVHMDVIMLAHNPGGKERTEQEFEALAKGSGFQGIRVCCDAFNTYVIEFLKKI

SEQ ID NO: 11 - protein, 271 aa, Homo sapiens
MPEAPPLLLAAVLLGLVLLVVLLLLLRHWGWGLCLIGWNEFILQPIHNLLMGDTKEQRILNHVLQHAEPGNAQSVLEAIDTYCEQKEWAMNVGDKKGKIVDAVIQEHQPSVLLELGAYCGYSAVRMARLLSPGARLITIEINPDCAAITQRMVDFAGVKDKVTLVVGASQDIIPQLKKKYDVDTLDMVFLDHWKDRYLPDTLLLEECGLLRKGTVLLADNVICPGAPDFLAHVRGSSCFECTHYQSFLEYREVVDGLEKAIYKGPGSEAGP

SEQ ID NO: 12 - protein, 1174 aa, Nocardia iowensis
MAVDSPDERLQRRIAQLFAEDEQVKAARPLEAVSAAVSAPGMRLAQIAATVMAGYADRPAAGQRAFELNTDDATGRTSLRLLPRFETITYRELWQRVGEVAAAWHHDPENPLRAGDFVALLGFTSIDYATLDLADIHLGAVTVPLQASAAVSQLIAILTETSPRLLASTPEHLDAAVECLLAGTTPERLVVFDYHPEDDDQRAAFESARRRLADAGSLVIVETLDAVRARGRDLPAAPLFVPDTDDDPLALLIYTSGSTGTPKGAMYTNRLAATMWQGNSMLQGNSQRVGINLNYMPMSHIAGRISLFGVLARGGTAYFAAKSDMSTLFEDIGLVRPTEIFFVPRVCDMVFQRYQSELDRRSVAGADLDTLDREVKADLRQNYLGGRFLVAVVGSAPLAAEMKTFMESVLDLPLHDGYGSTEAGASVLLDNQIQRPPVLDYKLVDVPELGYFRTDRPHPRGELLLKAETTIPGYYKRPEVTAEIFDEDGFYKTGDIVAELEHDRLVYVDRRNNVLKLSQGEFVTVAHLEAVFASSPLIRQIFIYGSSERSYLLAVIVPTDDALRGRDTATLKSALAESIQRIAKDANLQPYEIPRDFLIETEPFTIANGLLSGIAKLLRPNLKERYGAQLEQMYTDLATGQADELLALRREAADLPVLETVSRAAKAMLGVASADMRPDAHFTDLGGDSLSALSFSNLLHEIFGVEVPVGVVVSPANELRDLANYIEAERNSGAKRPTFTSVHGGGSEIRAADLTLDKFIDARTLAAADSIPHAPVPAQTVLLTGANGYLGRFLCLEWLERLDKTGGTLICVVRGSDAAAARKRLDSAFDSGDPGLLEHYQQLAARTLEVLAGDIGDPNLGLDDATWQRLAETVDLIVHPAALVNHVLPYTQLFGPNVVGTAEIVRLAITARRKPVTYLSTVGVADQVDPAEYQEDSDVREMSAVRVVRESYANGYGNSKWAGEVLLREAHDLCGLPVAVFRSDMILAHSRYAGQLNVQDVFTRLILSLVATGIAPYSFYRTDADGNRQRAHYDGLPADFTAAAITALGIQATEGFRTYDVLNPYDDGISLDEFVDWLVESGHPIQRITDYSDWFHRFETAIRALPEKQRQASVLPLLDAYRNPCPAVRGAILPAKEFQAAVQTAKIGPEQDIPHLSAPLIDKYVSDLELLQLL

SEQ ID NO: 13 - protein, 217 aa, Corynebacterium glutamicum
MLDESLFPNSAKFSFIKTGDAVNLDHFHQLHPLEKALVAHSVDIRKAEFGDARWCAHQALQALGRDSGDPILRGERGMPLWPSSVSGSLTHTDGFRAAVVAPRLLVRSMGLDAEPAEPLPKDVLGSIARVGEIPQLKRLEEQGVHCADRLLFCAKEATYKAWFPLTHRWLGFEQAEIDLRDDGTFVSYLLVRPTPVPFISGKWVLRDGYVIAATAVT

SEQ ID NO: 14 - protein, 209 aa, Escherichia coli
MVDMKTTHTSLPFAGHTLHFVEFDPANFCEQDLLWLPHYAQLQHAGRKRKTEHLAGRIAAVYALREYGYKCVPAIGELRQPVWPAEVYGSISHCGTTALAVVSRQPIGIDIEEIFSVQTARELTDNIITPAEHERLADCGLAFSLALTLAFSAKESAFKASEIQTDAGFLDYQIISWNKQQVIIHRENEMFAVHWQIKEKIVITLCQHD

SEQ ID NO: 15 - protein, 222 aa, Nocardia farcinica
MIENILPSGVAAAELLEYPEDLKPHPAEEHLIAQSVEKRRRDFIGARHCARLALRELGEPPVAIGKGERGAPVWPRGIVGSLTHCDGYRAAALAHKIRFRSVGIDAEPHGPLPDGVLDSVSLPQEREWLRRTDSGLHLDRLLFCAKEATYKAWFPLTARWLGFEDAHITFTVEEDGAGGGSGTFHTDLLVPGQTTDGGLPLTSFDGRWLIADGLILTAIVHD

SEQ ID NO: 16 - protein, 563 aa, Fusarium verticillioides
MTTVNPLVLPPGIAPSAFHQFISEITEVTTSENVVIISNPGQLDKQDYRDPSKMHDMFDITSKQHFVSSAVVTPRDVAEVQAIVKLCNKFEIPLWPFSIGRNVGYGGAAPRVPGSIGLDLGKHMNKILKVDVDGAYALVEPGVTYADLHHYLVDKNLRDKLWIDVPDLGGGSVLGNTTERGVGYTPYGDHFMMHCGMEVVLPDGTLVRTGMGALPNPDADPNAPPHEQEPNSAWQLFNYGFGPYNDGIFTQSSLGIVVKMGIWLMVNPGGYQSYLITIPKDEDLHQAIEIIRPLRTSIVLQNVPTVRHVLLDAAVMGSRDKYTTSKKPLNDKELDDIANKLNLGRWNFYGALYGPEPIRKVMWEVVKGAFSAIPGAKFYFPEDMPDNVVLQTRDLTLQGIPTMTELEWVNWLPNGAHLFFSPIAKVTGDDAVAQYTLTRKRCEEAGFDFIGTFVVGMREMHHIVCLVFDRLDPESCRRAHALISQLIDDAAKKGWGEYRTHLALMDQIAQTYNFNGNAQMYLNTTIKNALDPKGILAPGKNGIWPSGYNAKDFAVTPQRSTKL

SEQ ID NO: 17 - protein, 560 aa, Penicillium simplicissimum
MSKTQEFRPLTLPPKLSLSDFNEFIQDIIRIVGSENVEVISSKDQIVDGSYMKPTHTHDPHHVMDQDYFLASAIVAPRNVADVQSIVGLANKFSFPLWPISIGRNSGYGGAAPRVSGSVVLDMGKNMNRVLEVNVEGAYCVVEPGVTYHDLHNYLEANNLRDKLWLDVPDLGGGSVLGNAVERGVGYTPYGDHWMMHSGMEVVLANGELLRTGMGALPDPKRPETMGLKPEDQPWSKIAHLFPYGFGPYIDGLFSQSNMGIVTKIGIWLMPNPRGYQSYLITLPKDGDLKQAVDIIRPLRLGMALQNVPTIRHILLDAAVLGDKRSYSSRTEPLSDEELDKIAKQLNLGRWNFYGALYGPEPIRRVLWETIKDAFSAIPGVKFYFPEDTPENSVLRVRDKTMQGIPTYDELKWIDWLPNGAHLFFSPIAKVSGEDAMMQYAVTKKRCQEAGLDFIGTFTVGMREMHHIVCIVFNKKDLIQKRKVQWLMRTLIDDCAANGWGEYRTHLAFMDQIMETYNWNNSSFLRFNEVLKNAVDPNGIIAPGKSGVWPSQYSHVTWKL

SEQ ID NO: 18 - protein, 529 aa, Modestobacter marinus
MARVLPPGLAEPDFDTAIARFREVVGDKYVVTEDGDLARYRDPYPVGSEPATGASAAISPETTEQVQEIVRIANEVGIPLSPISTGKNNGYGGGQPRLSGAVVVNTGERMNRILEVNEKYGYALLEPGVSYFDLYEYLQANAPSLMLDCPDLGWGSVVGNTLDRGVGYTPYGDHLMWQTGLEVVLPTGAVMRTGMGAVPGSNTWQLFQYGFGPFPDGLFTQSNLGIVTKMGIQLMQRPPASTTFVITFDAEEDLAQVVDIMFPLRVNMAPLQNVPVLRNIILDAGVVSKRTEWYDGDGPLPAEAIERMKSELGLGYWNLYGTVYGPPPVVEQYLGMIRDAFLQVPGSQFSTHHDRDEATDRGAHVLHDRHRINNGIPSLDEMKLLEFVPNGGHLGFSPVSAPDGADALRQAQMVRQRADEYGQDYAAQFIVGLREMHHIALLLFDTSKAEQRQRALDLARVLIDEAAAEGYGEYRTHNALMDQVMATYNWGDGALREFHEAIKDALDPNSIMAPGKSGIWGRKYRDQQH

SEQ ID NO: 19 - protein, 526 aa, Rhodococcus jostii
MTRTLPPGVSDERFDAALQRFRDVVGDKWVLSTADELEAFRDPYPVGAAEANLPSAVVSPESTEQVQDIVRIANEYGIPLSPVSTGKNNGYGGAAPRLSGSVIVKTGERMNRILEVNEKYGYALLEPGVTYFDLYEYLQSHDSGLMLDCPDLGWGSVVGNTLDRGVGYTPYGDHFMWQTGLEVVLPQGEVMRTGMGALPGSDAWQLFPYGFGPFPDGMFTQSNLGIVTKMGIALMQRPPASQSFLITFDKEEDLEQIVDIMLPLRINMAPLQNVPVLRNIFMDAAAVSKRTEWFDGDGPMPAEAIERMKKDLDLGFWNFYGTLYGPPPLIEMYYGMIKEAFGKIPGARFFTHEERDDRGGHVLQDRHKINNGIPSLDELQLLDWVPNGGHIGFSPVSAPDGREAMKQFEMVRNRANEYNKDYAAQFIIGLREMHHVCLFIYDTAIPEAREEILQMTKVLVREAAEAGYGEYRTHNALMDDVMATFNWGDGALLKFHEKIKDALDPNGIIAPGKSGIWSQRFRGQNL

SEQ ID NO: 20 - protein, 526 aa, Rhodococcus opacus
MTRTLPPGVSDERFDAALQRFRDIVGDKWVLSTADELEAFRDPYPVGAAEANIPSAVVSPESTEQVQDIVRIANEYGIPLSPVSTGKNNGYGGAAPRLSGSVIVKTGERMNRILEVNEKYGYALLEPGVTYFDLYDYLQSHDSGLMLDCPDLGWGSVVGNTLDRGVGYTPYGDHFMWQTGLEVVLPQGDVMRTGMGALPGSDAWQLFPYGFGPFPDGMFTQSNLGIVTKMGIALMQRPPASQSFLITFDKEEDLEQIVDIMLPLRINMAPLQNVPVLRNIFMDAAAVSKRTEWFDGDGPMPAEAIERMKKDLDLGFWNFYGTLYGPPPLIEMYYGMIKEAFGKIPGARFFTHEERDDRGGHVLQDRHKINNGVPSLDELQLLDWVPNGGHIGFSPVSAPDGREAMKQFEMVRARADEYAKDYAAQFIIGLREMHHVCLFIYDTAIPDAREEILQMTKVLVREAADAGYGEYRTHNALMDDVMATFDWGDGALLKFHEKIKDALDPNGIIAPGKSGVWPQRFRGQKL

SEQ ID NO: 21 - protein, 271 aa, Homo sapiens; identical to SEQ ID NO: 11

SEQ ID NO: 22 - protein, 363 aa, Arabidopsis thaliana; identical to SEQ ID NO: 9

SEQ ID NO: 23 - protein, 365 aa, Fragaria x ananassa; identical to SEQ ID NO: 10

SEQ ID NO: 24 - protein, 367 aa, Podospora anserina
MPSKLAITSMSLGRCYAGHSFTTKLDMARKYGYQGLELFHEDLADVAYRLSGETPSPCGPSPAAQLSAARQILRMCQVRNIEIVCLQPFSQYDGLLDREEHERRLEQLEFWIELAHELDTDIIQIPANFLPAEEVTEDISLIVSDLQEVADMGLQANPPIRFVYEALCWSTRVDTWERSWEVVQRVNRPNFGVCLDTFNIAGRVYADPTVASGRTPNAEEAIRKSIARLVERVDVSKVFYVQVVDAEKLKKPLVPGHRFYDPEQPARMSWSRNCRLFYGEKDRGAYLPVKEIAWAFFNGLGFEGWVSLELFNRRMSDTGFGVPEELARRGAVSWAKLVRDMKITVDSPTQQQATQQPIRMLSLSAAL

SEQ ID NO: 25 - protein, 345 aa, Ustilago maydis
MSSIASTSASTMQHPRYSIFTHSVGYHTSKHGLLSKLDAISAAGLAGVEMFTDDLWSFAQSDEFGSILAASERETELLTPPDSPLSQPASLRNKTRIHENAERAGQHYSAHGACTPDERQREIAAATFIRSYCASRRLQVECLQPLRDVEGWLKDEDRENAIERVKSRFDIMRALDTHLLLICSQNTRAPQTTGDMATIVRDLTHISDLAAAYTAQTGFEIKIGYEALSWGAHIDLWSQAWNIVRTVDRDNIGLILDSFNTLAREFADPCTRSGIQEPICTTLTSLHSSLQAIQSVPADKIFLLQIGDARRLPEPLVPSPRDGEPRPSRMIWSRSSRLMPSSKAS

SEQ ID NO: 26 - protein, 644 aa, Rhodococcus jostii
MGRQVRTSVATVSLSGSLEEKVTAIAAAGFDGFEVFEPDFVSSPWSPRELASRAADLGLTLDLYQPFRDLDSVDEATFARNLIRAERKFDIMEQLGCDTLLVCSSPLPEAVRDDARLTEQLHTLAERAHSRGLRIAYEALAWGTHVNTYRHAWKIVQDADHHALGTCLDSFHILSRGDDPSGIRDIPGEKIFFLQLADAPRMSMDILQWSRHHRNFPGQGNFDLATFGAHVQAAGYSGPWSLEIFNDTFRQSSTGRTAADAHRSLLYLQEEVARVQAEHGEDTGRGLALFEPPPRAPLEGIVSLRLAAGPGKDSDLRQALQHIGFRLVGRHRSHDLQLWRHGRMTIVVDATAGTVWTAPGLPAHLPVLTQIGIRSSDPDAWGERAAALEVPVHEVLLPGVDTAPESDVVRLKITDATSLDLRGPGSAASWQSAFDLYPTESRWQDEVPVFTGVDHVALAVPSDNWDGIMLLLRSVFAMAPHEGLDVTDAVGMMRSQALTMDQTGADGIDRPLRISLNMVPGAVSGNSHIAAARRGGISHVAFSCTDIFTAAATMQSNGFDPLVISPNYYDDLEARFGLSRELLDRMSGSGIMYDADAHGEFFHLFTQTVGADLFFEVVQRVGGYEGYGDANSAMRLAAQLRAAG

SEQ ID NO: 27 - protein, 486 aa, Acinetobacter sp. ADP1
MKLTSLRVSLLALGLVTSGFAAAETYTVDRYQDDSEKGSLRWAIEQSNANSAQENQILIQAVGKAPYVIKVDKPLPPIKSSVKIIGTEWDKTGEFIAIDGSNYIKGEGEKACPGANPGQYGTNVRTMTLPGLVLQDVNGVTLKGLDVHRFCIGVLVNRSSNNLIQHNRISNNYGGAGVMITGDDGKGNPTSTTTNNNKVLDNVFIDNGDGLELTRGAAFNLIANNLFTSTKANPEPSQGIEILWGNDNAVVGNKFENYSDGLQINWGKRNYIAYNELTNNSLGFNLTGDGNIFDSNKVHGNRIGIAIRSEKDANARITLTKNQIWDNGKDIKRCEAGGSCVPNQRLGAIVFGVPALEHEGFVGSRGGGVVIEPAKLQKTCTQPNQQNCNAIPNQGIQAPKLTVSKKQLTVEVKGTPNQRYNVEFFGNRNASSSEAEQYLGSIVVVTDHQGLAKANWAPKVSMPSVTANVTDHLGATSELSSAVKMR

SEQ ID NO: 28 - protein, 371 aa, Aspergillus niger
MPNRLGIASMSLGRPGIHSLPWKLHEAARHGYSGIELFFDDLDHYATTHFNGSHIAAAHAVHALCTTLNLTIICLQPFSFYEGLVDRKQTEYLLTVKLPTWFQLARILDTDMIQVPSNFAPAQQTTGDRDVIVGDLQRLADIGLAQSPPFRFVYEALAWGTRVNLWDEAYEIVEAVDRPNFGICLDTFNLAGRVYAHPGRQDGKTVNAEADLAASLKKLRETVDVKKVFYVQVVDGERLERPLDETHPFHVEGQPVRMNWSRNARLFAFEEDRGGYLPIEETARAFFDTGFEGWVSLELFSRTLAEKGTGVVTEHARRGLESWKELCRRLEFKGAEPGLDFVPGEVKVQSVAVGSGKGVEQEEMGVVQHRL

SEQ ID NO: 29 - protein, 340 aa, Neurospora crassa
MPFALASCSIGLPKHTLHQKIEAIRHAGFDGIELSFPDLQSYANLHFGRDIAEDDYDTLCEAGQAVRTLVERHNLNIFVLQPFSNFEGWPEGSKKREDAFARARGWIRIMEAVGTDMLQVGSSDSEGIATDPERVAADLRELADMLVEKGFKLAYENWCWSTHAPKWSDVWNIVQKVDRPNVGLCLDTFQSAGGEWGDPTTESGRIETPAITEMELSVRYRASLKELAETVPADKIFFFQISDAYKVQPPLDDKPDPESGLRPRGRWSHDYRPLPYDGGYLPIEQFAKAVLDTGFKGWFSVEVFDGKFEEKFGQDLNKYAQKAMDSCKELLSKAKEKETQ

(19) United States
(12) Patent Application Publication
(10) Pub. No.: US 2017/0172184 A1
(43) Pub. Date: Jun. 22, 2017

(54) Methods of Improving Production of Vanillin

(71) Applicant: EVOLVA SA, Reinach (CH)

(72) Inventors: Neil GOLDSMITH, Reinach (CH); Esben Halkjaer HANSEN, Frederiksberg (DK); Jean-Philippe MEYER, Mulhouse (FR); Federico BRIANZA, Riehen (CH)

(21) Appl. No.: 15/118,170

(22) PCT Filed: Feb. 12, 2015
(86) PCT No.: PCT/EP2015/053022

§ 371 Date: Aug. 11, 2016

Related U.S. Application Data
(60) Provisional application No. 61/939,236, filed on Feb. 12, 2014.

(51) Int. Cl. A23L 2/56; A23L 27/24

(52) U.S. Cl. CPC A23L 2/56; A23L 27/24; A23V 2002/00

(57) ABSTRACT

Methods for recombinant production of vanillin and compositions containing vanillin are provided by this invention.

### BACKGROUND OF THE INVENTION

Field of the Invention

The invention disclosed herein relates generally to the field of recombinant production of vanillin. Particularly, the invention provides methods for recombinant production of vanillin and compositions containing vanillin.

Description of Related Art

Vanilla is recognized as one of the most popular flavors and aromas around the world. Over 100 varieties of the vanilla plant exist, but the three main species grown for commercial use are Vanilla planifolia, Vanilla pompona, and Vanilla tahitensis. Vanilla plants require humid, tropical, or subtropical climates of countries or regions such as Madagascar, Indonesia, Mexico, French Polynesia, and the West Indies.

The cultivation process of the vanilla plant has proven time-consuming and tedious. Flowering occurs approximately two to three years after planting. The flowers must then be pollinated by hand because of physical separation of the stigma and stamen because few natural pollinators of the vanilla plant exist. Pollination must be performed daily over a four month period. Approximately eight months after pollination, seed pods are ready to be harvested. It is crucial that harvesting occurs at the proper time. For example, if harvesting is done too early, the vanilla beans may have a lower content of vanillin (4-hydroxy-3-methoxybenzaldehyde, methylprotocatechuic aldehyde, vanillaldehyde, vanillic aldehyde). Vanillin (CAS#121-33-5) is most responsible for the flavor and fragrance profiles of vanilla, and vanillin content is also affected by the region in which the plants are grown and the curing process following harvesting. Curing may take several months in order to develop the flavor and aroma of the vanilla bean. During this time, glucovanillin is converted to vanillin by the activity of endogenous β-glucosidase activity. See Voisine et al., 1995, J. Agric. Food Chem. 43: 2658-2661 and Ruiz-Teran et al., 2001, J. Agric. Food Chem. 49: 5207-5209.

In the vanilla plant, tyrosine is converted to 4-coumaric acid, which is then converted to ferulic acid, and ferulic acid is converted into vanillin. In the mature seed pod, vanillin is in the β-D-glucoside form, known as glucovanillin. See Negishi et al. J. Agric. Food Chem. 57: 9959-9961 (2009).

In addition to vanillin, vanilla contains approximately 250 other compounds, including para-hydroxy benzaldehyde and para-hydroxy benzoic acid. One or more of these compounds can alter or contribute to off-flavors of vanilla. These off-flavors can be more or less problematic depending on the food system or application of choice. Potential contaminants include p-hydroxybenzoic acid, coumarin, ferulic acid, 4-vinylguaiacol, isoeugenol, 5-formylvanillin, para-hydroxybenzaldehyde, acetovanillon, dehydro-di-vanillin, 5-carboxyvanillin, ethyl vanillin, orthovanillin, 4-(hydroxymethyl)-2-methoxyphenol, mandelic acid, coniferyl alcohol, coniferyl aldehyde, 2-methoxy-4-vinylphenol, guaiacol, eugenol, and tumeric. Conditions not limited to climate, soil nutrients, and extraction methods also influence vanilla compositions. As a consequence, vanilla can vary greatly from batch-to-batch, and droughts, natural disasters, and deforestation have contributed to lower production and a higher cost of vanilla. Therefore, there remains a need for an in vivo expression system that can produce high, reproducible, pure yields of vanillin.

### SUMMARY OF THE INVENTION

It is against the above background that the present invention provides certain advantages and advancements over the prior art.

The invention is directed to biosynthesis of vanillin preparations from genetically modified cells.

In particular embodiments, the invention is directed to vanillin preparations from genetically modified cells having significantly improved biosynthesis rates and yields.

This disclosure relates to the production of vanillin. In particular, this disclosure relates to the production of vanillin having the chemical structure:

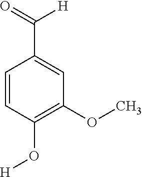

by means not limited to production in recombinant hosts such as recombinant microorganisms, through whole cell bioconversion, and through in vitro processes.

Thus, in one aspect, the disclosure provides a recombinant host, for example, a microorganism, comprising one or more heterologous biosynthetic genes introduced thereto, wherein the expression of one or more biosynthetic genes results in production of vanillin.

Although this invention as disclosed herein is not limited to specific advantages or functionalities, the invention provides generally a vanillin composition comprising from about 1% to about 99.9% w/w of vanillin, wherein the composition has a reduced level of contaminants relative to a plant-derived vanillin extract or a vanillin composition produced by an in vitro process, by whole cell bioconversion, or by fermentation.

In some aspects, the vanillin composition disclosed herein has less than 0.1% of contaminants relative to a plant-derived vanillin extract or a vanillin composition produced by the in vitro process, by whole cell bioconversion, or by fermentation.

In some aspects, at least one of the contaminants in the the vanillin composition disclosed herein is a compound that contributes to off-flavors.

In some aspects, the composition contains a reduced amount of one or a plurality of 2-methoxy-4-vinylphenol, 3-bromo-4-hydroxybenzaldehyde, 3-methoxy-4-hydroxybenzyl alcohol, 4-vinylguaiacol, acetovanillon, coniferyl alcohol, coniferyl aldehyde, coumarin, dehydro-di-vanillin, ethyl vanillin, eugenol, ferulic acid, glyoxylic acid, guaiacol, isoeugenol, mandelic acid, O-benzylvanillin, orthovanillin, para-hydroxybenzaldehyde, p-hydroxybenzoic acid, 5-carboxyvanillin, 5-formylvanillin, turmeric, and/or 4-(hydroxymethyl)-2-methoxyphenol.

In some aspects, the composition contains a reduced amount of one or a plurality of 2-methyloctadecane, 8,11,14-eicosatrienoic acid, α-amyrin, β-amyrin, β-amyrin, acetate, β-pinene, β-sitosterol, calcium gluconate, calcium phytate, carboxymethyl cellulose, carnauba wax, carophyllene, carophyllene derivatives, cellulose acetate, centauredin, copper gluconate, cuprous iodide, decanoic acid, epi-alpha-cadinol, ethyl cellulose, gibberellin, hydroxypropylmethyl cellulose, lupeol, methylcellulose, octacosane, octadecanol, pentacosane, quercetin, sodium carboxymethyl cellulose, spathulenol, stigmasterol, and/or tetracosane.

In some aspects, the composition contains a reduced amount of one or a plurality of compounds of Table 4.

The invention further provides a method for producing vanillin, comprising:

(a) culturing a recombinant host in a culture medium, under conditions wherein, genes encoding a COMT polypeptide having 80% or greater identity to the amino acid sequence set forth in SEQ ID NO:8, an AROM polypeptide having 80% or greater identity to the amino acid sequence set forth in SEQ ID NO:4, a 3DSD polypeptide having 80% or greater identity to the amino acid sequence set forth in SEQ ID NO:24, NO:25, NO:26, NO:27, NO:28, NO:29, an ACAR polypeptide having 80% or greater identity to the amino acid sequence set forth in SEQ ID NO:12, a VAO polypeptide having 80% or greater identity to the amino acid sequence set forth in SEQ ID NO:16, NO:17, NO:18, NO:19, NO:20, an OMT polypeptide having 80% or greater identity to the amino acid sequence set forth in SEQ ID NO:21, NO:22, NO:23, and/or a PPTase polypeptide having 80% or greater identity to the amino acid sequence set forth in SEQ ID NO:13, NO:14, NO:15 are expressed, comprising inducing expression of said genes or constitutively expressing said genes; and

(b) synthesizing vanillin in the recombinant host; and optionally

(c) isolating vanillin from the recombinant host and/or culture medium.

In some aspects, the recombinant host expresses polypeptides comprising a COMT polypeptide having 80% or greater identity to the amino acid sequence set forth in SEQ ID NO:8, an AROM polypeptide having 80% or greater identity to the amino acid sequence set forth in SEQ ID NO:4, a 3DSD polypeptide having 80% or greater identity to the amino acid sequence set forth in SEQ ID NO:24, NO:25, NO:26, NO:27, NO:28, NO:29, a ACAR polypeptide having 80% or greater identity to the amino acid sequence set forth in SEQ ID NO:12, a VAO polypeptide having 80% or greater identity to the amino acid sequence set forth in SEQ ID NO:16, NO:17, NO:18, NO:19, NO:20, a OMT polypeptide having 80% or greater identity to the amino acid sequence set forth in SEQ ID NO:21, NO:22, NO:23, and/or a PPTase polypeptide having 80% or greater identity to the amino acid sequence set forth in SEQ ID NO:13, NO:14, NO:15.

In some aspects, the recombinant host is a yeast cell, a plant cell, a mammalian cell, an insect cell, a fungal cell, or a bacterial cell.

In some aspects, the yeast cell is a cell from Saccharomyces cerevisiae, Schizosaccharomyces pombe, Yarrowia lipolytica, Candida glabrata, Ashbya gossypii, Cyberlindnera jadinii, Pichia pastoris, Kluyveromyces lactis, Hansenula polymorpha, Candida boidinii, Arxula adeninivorans, Xanthophyllomyces dendrorhous, or Candida albicans species.

In some aspects, the yeast cell is a Saccharomycete.

In some aspects, the yeast cell is a cell from the Saccharomyces cerevisiae species.

In some aspects of the methods disclosed herein, vanillin is produced by fermentation.

In some aspects, the culture medium for said recombinant host does not comprise one or a plurality of 2-methoxy-4-vinylphenol, 3-bromo-4-hydroxybenzaldehyde, 3-methoxy-4-hydroxybenzyl alcohol, 4-vinylguaiacol, acetovanillon, coniferyl alcohol, coniferyl aldehyde, coumarin, dehydro-di-vanillin, ethyl vanillin, eugenol, ferulic acid, glyoxylic acid, guaiacol, isoeugenol, mandelic acid, O-benzylvanillin, orthovanillin, para-hydroxybenzaldehyde, p-hydroxybenzoic acid, 5-carboxyvanillin, 5-formylvanillin, turmeric, and/or 4-(Hydroxymethyl)-2-methoxyphenol.

In some aspects, the culture medium for said recombinant host does not comprise one or a plurality of compounds of Table 4.

The invention further discloses a method for producing vanillin comprising an in vitro production process using one or a plurality of the polypeptides comprising a COMT polypeptide having 80% or greater identity to the amino acid sequence set forth in SEQ ID NO:8, an AROM polypeptide having 80% or greater identity to the amino acid sequence set forth in SEQ ID NO:4, a 3DSD polypeptide having 80% or greater identity to the amino acid sequence set forth in SEQ ID NO:24, NO:25, NO:26, NO:27, NO:28, NO:29, an ACAR polypeptide having 80% or greater identity to the amino acid sequence set forth in SEQ ID NO:12, a VAO polypeptide having 80% or greater identity to the amino acid sequence set forth in SEQ ID NO:16, NO:17, NO:18, NO:19, NO:20, an OMT polypeptide having 80% or greater identity to the amino acid sequence set forth in SEQ ID NO:21, NO:22, NO:23, and/or a PPTase polypeptide having 80% or greater identity to the amino acid sequence set forth in SEQ ID NO:13, NO:14, NO:15.

In some aspects, the bioconversion comprises enzymatic bioconversion or whole cell bioconversion.

In some aspects, the cell of the whole cell bioconversion is a yeast cell, a plant cell, a mammalian cell, an insect cell, a fungal cell, or a bacterial cell.

In some aspects, the yeast cell is a cell from Saccharomyces cerevisiae, Schizosaccharomyces pombe, Yarrowia lipolytica, Candida glabrata, Ashbya gossypii, Cyberlindnera jadinii, Pichia pastoris, Kluyveromyces lactis, Hansenula polymorpha, Candida boidinii, Arxula adeninivorans, Xanthophyllomyces dendrorhous, or Candida albicans species.

In some aspects, the yeast cell is a Saccharomycete.

In some aspects, the yeast cell is a cell from Saccharomyces cerevisiae species.

The invention further provides an in vitro method for producing vanillin, comprising:

(a) adding one or more of a COMT polypeptide having 80% or greater identity to the amino acid sequence set forth in SEQ ID NO:8, an AROM polypeptide having 80% or greater identity to the amino acid sequence set forth in SEQ ID NO:4, a 3DSD polypeptide having 80% or greater identity to the amino acid sequence set forth in SEQ ID NO:24, NO:25, NO:26, NO:27, NO:28, NO:29, an ACAR polypeptide having 80% or greater identity to the amino acid sequence set forth in SEQ ID NO:12, a VAO polypeptide having 80% or greater identity to the amino acid sequence set forth in SEQ ID NO:16, NO:17, NO:18, NO:19, NO:20, an OMT polypeptide having 80% or greater identity to the amino acid sequence set forth in SEQ ID NO:21, NO:22, NO:23, and/or a PPTase polypeptide having 80% or greater identity to the amino acid sequence set forth in SEQ ID NO:13, NO:14, NO:15, and fermented vanillin to the reaction mixture; and

(b) synthesizing vanillin in the reaction mixture; and optionally

(c) isolating vanillin.

In some aspects, the in vitro method is an enzymatic in vitro method or whole cell in vitro method.

In some aspects, the cell of the whole cell in vitro method is a yeast cell, a plant cell, a mammalian cell, an insect cell, a fungal cell, or a bacterial cell.

In some aspects, the yeast cell is a cell from Saccharomyces cerevisiae, Schizosaccharomyces pombe, Yarrowia lipolytica, Candida glabrata, Ashbya gossypii, Cyberlindnera jadinii, Pichia pastoris, Kluyveromyces lactis, Hansenula polymorpha, Candida boidinii, Arxula adeninivorans, Xanthophyllomyces dendrorhous, or Candida albicans species.

In some aspects, the yeast cell is a Saccharomycete.

In some aspects, the yeast cell is a cell from Saccharomyces cerevisiae species.

The invention further provides vanillin produced by the methods disclosed herein.

The invention further provides a food product comprising the composition disclosed herein.

In some aspects, the food product is a beverage or a beverage concentrate.

The invention further provides a method for producing vanillin by fermentation in a yeast cell, comprising:

(a) fermenting the yeast cell in a culture medium, under conditions wherein, genes encoding a COMT polypeptide having 80% or greater identity to the amino acid sequence set forth in SEQ ID NO:8, an AROM polypeptide having 80% or greater identity to the amino acid sequence set forth in SEQ ID NO:4, a 3DSD polypeptide having 80% or greater identity to the amino acid sequence set forth in SEQ ID NO:24, NO:25, NO:26, NO:27, NO:28, NO:29, an ACAR polypeptide having 80% or greater identity to the amino acid sequence set forth in SEQ ID NO:12, a VAO polypeptide having 80% or greater identity to the amino acid sequence set forth in SEQ ID NO:16, NO:17, NO:18, NO:19, NO:20, an OMT polypeptide having 80% or greater identity to the amino acid sequence set forth in SEQ ID NO:21, NO:22, NO:23, and/or a PPTase polypeptide having 80% or greater identity to the amino acid sequence set forth in SEQ ID NO:13, NO:14, NO:15 are expressed, comprising inducing expression of said genes or constitutively expressing said genes; and

(b) producing vanillin in the cell; and optionally

(c) isolating vanillin from the cell and/or culture medium.

In some aspects, the yeast cell expresses polypeptides comprising a COMT polypeptide having 80% or greater identity to the amino acid sequence set forth in SEQ ID NO:8, an AROM polypeptide having 80% or greater identity to the amino acid sequence set forth in SEQ ID NO:4, a 3DSD polypeptide having 80% or greater identity to the amino acid sequence set forth in SEQ ID NO:24, NO:25, NO:26, NO:27, NO:28, NO:29, a ACAR polypeptide having 80% or greater identity to the amino acid sequence set forth in SEQ ID NO:12, a VAO polypeptide having 80% or greater identity to the amino acid sequence set forth in SEQ ID NO:16, NO:17, NO:18, NO:19, NO:20, a OMT polypeptide having 80% or greater identity to the amino acid sequence set forth in SEQ ID NO:21, NO:22, NO:23, and/or a PPTase polypeptide having 80% or greater identity to the amino acid sequence set forth in SEQ ID NO:13, NO:14, NO:15.

In some aspects, the culture medium for said yeast cell does not comprise one or a plurality of 2-methoxy-4-vinylphenol, 3-bromo-4-hydroxybenzaldehyde, 3-methoxy-4-hydroxybenzyl alcohol, 4-vinylguaiacol, acetovanillon, coniferyl alcohol, coniferyl aldehyde, coumarin, dehydro-di-vanillin, ethyl vanillin, eugenol, ferulic acid, glyoxylic acid, guaiacol, isoeugenol, mandelic acid, O-benzylvanillin, orthovanillin, para-hydroxybenzaldehyde, p-hydroxybenzoic acid, 5-carboxyvanillin, 5-formylvanillin, turmeric, and/or 4-(Hydroxymethyl)-2-methoxyphenol.

In some aspects, the culture medium for said yeast cell does not comprise one or a plurality of:

(a) 2-methoxy-4-vinylphenol;

(b) 3-bromo-4-hydroxybenzaldehyde;

(c) 3-methoxy-4-hydroxybenzyl alcohol;

(d) 4-vinylguaiacol;

(e) acetovanillon;

(f) coniferyl alcohol;

(g) coniferyl aldehyde;

(h) coumarin;

(i) dehydro-di-vanillin;

(j) ethyl vanillin;

(k) eugenol;

(l) ferulic acid

(m) glyoxylic acid;

(n) guaiacol;

(o) isoeugenol;

(p) mandelic acid;

(q) O-benzylvanillin;

(r) orthovanillin;

(s) para-hydroxybenzaldehyde;

(t) p-hydroxybenzoic acid;

(u) 5-carboxyvanillin;

(v) 5-formylvanillin;

(w) turmeric;

(x) 4-(Hydroxymethyl)-2-methoxyphenol, or

(y) one or a plurality of compounds of Table 4.

In some aspects of the methods disclosed herein the culture medium for said yeast cell does not comprise 2-methoxy-4-vinylphenol.

In some aspects of the methods disclosed herein the culture medium for said yeast cell does not comprise 3-bromo-4-hydroxybenzaldehyde.

In some aspects of the methods disclosed herein the culture medium for said yeast cell does not comprise 3-methoxy-4-hydroxybenzyl alcohol.

In some aspects of the methods disclosed herein the culture medium for said yeast cell does not comprise 4-vinylguaiacol.

In some aspects of the methods disclosed herein the culture medium for said yeast cell does not comprise acetovanillon.

In some aspects of the methods disclosed herein the culture medium for said yeast cell does not comprise coniferyl alcohol.

In some aspects of the methods disclosed herein the culture medium for said yeast cell does not comprise coniferyl aldehyde.

In some aspects of the methods disclosed herein the culture medium for said yeast cell does not comprise coumarin.

In some aspects of the methods disclosed herein the culture medium for said yeast cell does not comprise dehydro-di-vanillin.

In some aspects of the methods disclosed herein the culture medium for said yeast cell does not comprise ethyl vanillin.

In some aspects of the methods disclosed herein the culture medium for said yeast cell does not comprise eugenol.

In some aspects of the methods disclosed herein the culture medium for said yeast cell does not comprise ferulic acid.

In some aspects of the methods disclosed herein the culture medium for said yeast cell does not comprise glyoxylic acid.

In some aspects of the methods disclosed herein the culture medium for said yeast cell does not comprise guaiacol.

In some aspects of the methods disclosed herein the culture medium for said yeast cell does not comprise isoeugenol.

In some aspects of the methods disclosed herein the culture medium for said yeast cell does not comprise mandelic acid.

In some aspects of the methods disclosed herein the culture medium for said yeast cell does not comprise O-benzylvanillin.

In some aspects of the methods disclosed herein the culture medium for said yeast cell does not comprise orthovanillin.

In some aspects of the methods disclosed herein the culture medium for said yeast cell does not comprise para-hydroxybenzaldehyde.

In some aspects of the methods disclosed herein the culture medium for said yeast cell does not comprise p-hydroxybenzoic acid.

In some aspects of the methods disclosed herein the culture medium for said yeast cell does not comprise 5-carboxyvanillin.

In some aspects of the methods disclosed herein the culture medium for said yeast cell does not comprise 5-formylvanillin.

In some aspects of the methods disclosed herein the culture medium for said yeast cell does not comprise turmeric.

In some aspects of the methods disclosed herein the culture medium for said yeast cell does not comprise 4-(Hydroxymethyl)-2-methoxyphenol.

In some aspects of the methods disclosed herein the culture medium for said yeast cell does not comprise one or a plurality of compounds of Table 4.

In some aspects of the methods disclosed herein, the the yeast cell is a cell from Saccharomyces cerevisiae, Schizosaccharomyces pombe, Yarrowia lipolytica, Candida glabrata, Ashbya gossypii, Cyberlindnera jadinii, Pichia pastoris, Kluyveromyces lactis, Hansenula polymorpha, Candida boidinii, Arxula adeninivorans, Xanthophyllomyces dendrorhous, or Candida albicans species.

In some aspects, the the yeast cell is a Saccharomycete.

In some aspects, the yeast cell is a cell from the Saccharomyces cerevisiae species.

The invention further provides a vanillin produced by the methods disclosed herein.

Any of the hosts described herein can be a microorganism (e.g., a Saccharomycete, such as Saccharomyces cerevisiae, or Escherichia coli).

In some aspects of the method disclosed herein, the culture media does not comprise one or a plurality of 2-methoxy-4-vinylphenol, 3-bromo-4-hydroxybenzaldehyde, 3-methoxy-4-hydroxybenzyl alcohol, 4-vinylguaiacol, acetovanillon, coniferyl alcohol, coniferyl aldehyde, coumarin, dehydro-di-vanillin, ethyl vanillin, eugenol, ferulic acid, glyoxylic acid, guaiacol, isoeugenol, mandelic acid, O-benzylvanillin, orthovanillin, para-hydroxybenzaldehyde, p-hydroxybenzoic acid, 5-carboxyvanillin, 5-formylvanillin, turmeric, 4-(Hydroxymethyl)-2-methoxyphenol, or one or a plurality of compounds of Table 4 prior to fermentation.

In some aspects of the method disclosed herein, the culture media does not comprise one or a plurality of 2-methoxy-4-vinylphenol, 3-bromo-4-hydroxybenzaldehyde, 3-methoxy-4-hydroxybenzyl alcohol, 4-vinylguaiacol, acetovanillon, coniferyl alcohol, coniferyl aldehyde, coumarin, dehydro-di-vanillin, ethyl vanillin, eugenol, ferulic acid, glyoxylic acid, guaiacol, isoeugenol, mandelic acid, O-benzylvanillin, orthovanillin, para-hydroxybenzaldehyde, p-hydroxybenzoic acid, 5-carboxyvanillin, 5-formylvanillin, turmeric, 4-(Hydroxymethyl)-2-methoxyphenol, or one or a plurality of compounds of Table 4 after fermentation.

These and other features and advantages of the present invention will be more fully understood from the following detailed description of the invention taken together with the accompanying claims. It is noted that the scope of the claims is defined by the recitations therein and not by the specific discussion of features and advantages set forth in the present description.

### BRIEF DESCRIPTION OF THE DRAWINGS

The following detailed description of the embodiments of the present invention can be best understood when read in conjunction with the following drawings, where like structure is indicated with like reference numerals and in which:

FIG. 1 is a schematic of de novo biosynthesis of vanillin (4) in an organism expressing 3-dehydroshikimate dehydratase (3DSD), aromatic carboxylic acid reductase (ACAR), O-methyltransferase (OMT), UDP glucuronosyltransferases (UGT), and phophopantheteine transferase (PPTase) polypeptides. Particular vanillin catabolites and metabolic side products, including dehydroshikimic acid (1), protocatechuic acid (2), protocatechuic aldehyde (3), protocatechuic alcohol (6), 4-(hydroxymethyl)-2-methoxyphenol alcohol (7), and vanillin β-D-glucoside (8) are also indicated. Open arrows show primary metabolic reactions in yeast, black arrows show enzyme reactions introduced by metabolic engineering, and diagonally striped arrows show undesired innate yeast metabolic reactions.

FIG. 2 shows initial steps of the shikimate pathway in Saccharomyces cerevisiae (S. cerevisiae).

FIG. 3 shows a pathway for vanillin synthesis in E. coli.

FIG. 4 shows levels of vanillin glucoside, vanillin, 4-(hydroxymethyl)-2-methoxyphenol alcohol glucoside, and 4-(hydroxymethyl)-2-methoxyphenol alcohol in yeast strains expressing Penicillium simplicissium (P. simplicissium; PS) or Rhodococcus jostii (R. jostii; RJ) 4-(hydroxymethyl)-2-methoxyphenol alcohol oxidase (VAO) and grown in media supplemented with 3 mM 4-(hydroxymethyl)-2-methoxyphenol alcohol.

FIG. 5 shows levels of vanillic acid, vanillin, and vanillin glucoside in yeast strains expressing Nocardia iowensis (N. iowensis) or N. crassa ACAR and of Escherichia coli (E. coli) or S. pombe phosphopantetheinyl transferase (PPTase) and grown in media supplemented with 3 mM vanillic acid.

FIG. 6 shows particular contaminants of vanillin.

FIG. 7A shows a UV trace of a vanillin analytical standard, FIG. 7B shows a UV trace of a ferulic acid analytical standard, FIG. 7C shows a UV trace of an ethyl vanillin analytical standard, FIG. 7D shows a UV trace of a mandelic acid analytical standard, FIG. 7E shows a UV trace of a eugenol analytical standard, FIG. 7F shows a UV trace of an isoeugenol analytical standard, and FIG. 7G shows a UV trace of a guaiacol analytical standard.

FIG. 8A shows a UV chromatogram of a vanillin analytical standard, FIG. 8B shows an extracted ion chromatogram (EIC) of the expected mass of vanillin present in a vanillin sample produced in yeast, FIG. 8C shows an EIC of the expected mass of ethyl vanillin present in a vanillin sample produced in yeast, FIG. 8D shows an EIC of the expected mass of ferulic acid present in a vanillin sample produced in yeast, FIG. 8E shows an EIC of the expected mass of mandelic acid present in a vanillin sample produced in yeast, FIG. 8F shows an EIC of the expected mass of eugenol/isoeugenol present in a vanillin sample produced in yeast, and FIG. 8G shows an EIC of the expected mass of guaiacol present in a vanillin sample produced in yeast. FIGS. 8C-8G show the absense of absence of ethyl vanillin, ferulic acid, mandelic acid, eugenol/isoeugenol, and guaiacol impurities.

FIG. 9A shows a UV chromatogram of a vanillin analytical standard (top panel), an EIC of the expected mass of ferulic acid present in a vanillin sample produced in yeast (middle panel), and an EIC of the expected mass of a ferulic acid analytical sample (bottom panel). FIG. 9B shows an EIC of the expected mass of ethyl vanillin present in a vanillin sample produced in yeast (top panel) and an EIC of the expected mass of an ethyl vanillin analytical sample (bottom panel). FIG. 9C shows a UV chromatogram of a vanillin analytical standard (top panel), an EIC of the expected mass of mandelic acid present in a vanillin sample produced in yeast (middle panel), and an EIC of the expected mass of a mandelic acid analytical sample (bottom panel). FIG. 9D shows an EIC of the expected mass of eugenol present in a vanillin sample produced in yeast (top panel) and an EIC of the expected mass of a eugenol analytical sample (bottom panel). FIG. 9E shows a UV chromatogram of a vanillin analytical standard (top panel), an EIC of the expected mass of isoeugenol present in a vanillin sample produced in yeast (middle panel), and an EIC of the expected mass of a isoeugenol analytical sample (bottom panel). FIG. 9F shows an EIC of the expected mass of guaiacol present in a vanillin sample produced in yeast (top panel) and an EIC of the expected mass of a guaiacol analytical sample (bottom panel). FIGS. 9B-9F show the absense of ferulic acid, ethyl vanillin, mandelic acid, eugenol, isoeugenol, and guaiacol impurities.

FIG. 10A shows a fingerprinting mass spectrum of vanillin, FIG. 10B shows a fingerprinting mass spectrum of ferulic acid, FIG. 100 shows a fingerprinting mass spectrum of ethyl vanillin, FIG. 10D shows a fingerprinting mass spectrum of mandelic acid, FIG. 10E shows a fingerprinting mass spectrum of eugenol, FIG. 10F shows a fingerprinting mass spectrum of isoeugenol, and FIG. 10G shows a fingerprinting mass spectrum of guaiacol.

FIG. 11 shows amino acid and nucleotide sequences used herein.

Skilled artisans will appreciate that elements in the Figures are illustrated for simplicity and clarity and have not necessarily been drawn to scale. For example, the dimensions of some of the elements in the Figures can be exaggerated relative to other elements to help improve understanding of the embodiment(s) of the present invention.

### DETAILED DESCRIPTION OF THE INVENTION

All publications, patents and patent applications cited herein are hereby expressly incorporated by reference for all purposes.

Methods well known to those skilled in the art can be used to construct genetic expression constructs and recombinant cells according to this invention. These methods include in vitro recombinant DNA techniques, synthetic techniques, in vivo recombination techniques, and polymerase chain reaction (PCR) techniques. See, for example, techniques as described in Maniatis et al., 1989, MOLECULAR CLONING: A LABORATORY MANUAL, Cold Spring Harbor Laboratory, New York; Ausubel et al., 1989, CURRENT PROTOCOLS IN MOLECULAR BIOLOGY, Greene Publishing Associates and Wiley Interscience, New York, and PCR Protocols: A Guide to Methods and Applications (Innis et al., 1990, Academic Press, San Diego, Calif.).

Before describing the present invention in detail, a number of terms will be defined. As used herein, the singular forms “a”, “an”, and “the” include plural referents unless the context clearly dictates otherwise. For example, reference to a “nucleic acid” means one or more nucleic acids.

It is noted that terms like “preferably”, “commonly”, and “typically” are not utilized herein to limit the scope of the claimed invention or to imply that certain features are critical, essential, or even important to the structure or function of the claimed invention. Rather, these terms are merely intended to highlight alternative or additional features that can or cannot be utilized in a particular embodiment of the present invention.

For the purposes of describing and defining the present invention it is noted that the term “substantially” is utilized herein to represent the inherent degree of uncertainty that can be attributed to any quantitative comparison, value, measurement, or other representation. The term “substantially” is also utilized herein to represent the degree by which a quantitative representation can vary from a stated reference without resulting in a change in the basic function of the subject matter at issue.

As used herein, the terms “polynucleotide”, “nucleotide”, “oligonucleotide”, and “nucleic acid” can be used interchangeably to refer to nucleic acid comprising DNA, RNA, derivatives thereof, or combinations thereof.

As used herein, the terms “microorganism,” “microorganism host,” “microorganism host cell,” “recombinant host,” and “recombinant host cell” can be used interchangeably. As used herein, the term “recombinant host” is intended to refer to a host, the genome of which has been augmented by at least one DNA sequence. Such DNA sequences include but are not limited to genes that are not naturally present, DNA sequences that are not normally transcribed into RNA or translated into a protein (“expressed”), and other genes or DNA sequences which one desires to introduce into the non-recombinant host. It will be appreciated that typically the genome of a recombinant host described herein is augmented through stable introduction of one or more recombinant genes. Generally, introduced DNA is not originally resident in the host that is the recipient of the DNA, but it is within the scope of this disclosure to isolate a DNA segment from a given host, and to subsequently introduce one or more additional copies of that DNA into the same host, e.g., to enhance production of the product of a gene or alter the expression pattern of a gene. In some instances, the introduced DNA will modify or even replace an endogenous gene or DNA sequence by, e.g., homologous recombination or site-directed mutagenesis. Suitable recombinant hosts include microorganisms.

As used herein, the term “recombinant gene” refers to a gene or DNA sequence that is introduced into a recipient host, regardless of whether the same or a similar gene or DNA sequence may already be present in such a host. “Introduced,” or “augmented” in this context, is known in the art to mean introduced or augmented by the hand of man. Thus, a recombinant gene can be a DNA sequence from another species, or can be a DNA sequence that originated from or is present in the same species, but has been incorporated into a host by recombinant methods to form a recombinant host. It will be appreciated that a recombinant gene that is introduced into a host can be identical to a DNA sequence that is normally present in the host being transformed, and is introduced to provide one or more additional copies of the DNA to thereby permit overexpression or modified expression of the gene product of that DNA. Said recombinant genes are particularly encoded by cDNA.

As used herein, the term “engineered biosynthetic pathway” refers to a biosynthetic pathway that occurs in a recombinant host, as described herein, and does not naturally occur in the host.

As used herein, the term “endogenous” gene refers to a gene that originates from and is produced or synthesized within a particular organism, tissue, or cell.

As used herein, the terms “heterologous sequence” and “heterologous coding sequence” are used to describe a sequence derived from a species other than the recombinant host. In some embodiments, the recombinant host is an S. cerevisiae cell, and a heterologous sequence is derived from an organism other than S. cerevisiae. A heterologous coding sequence, for example, can be from a prokaryotic microorganism, a eukaryotic microorganism, a plant, an animal, an insect, or a fungus different than the recombinant host expressing the heterologous sequence. In some embodiments, a coding sequence is a sequence that is native to the host.

As used herein, the terms “vanillin precursor” and “vanillin precursor compound” are used interchangeably to refer to intermediate compounds in the vanillin biosynthetic pathway. Vanillin precursors include, but are not limited to, dehydroshikimic acid, protocatechuic acid, protocatechuic aldehyde, and protocatechuic alcohol. Vanillin and vanillin precursors can be produced in vivo (i.e., in a recombinant host), in vitro (i.e., enzymatically), or by whole cell bioconversion.

In some embodiments, vanillin and vanillin precursors are produced in vivo through expression of one or more enzymes involved in the vanillin biosynthetic pathway in a recombinant host. For example, a vanillin-producing recombinant host expressing one or more of a gene encoding a 3DSD polypeptide, a gene encoding an ACAR polypeptide, a gene encoding an OMT polypeptide, a gene encoding a VAO polypeptide, a gene encoding a PPTase polypeptide, a gene encoding a COMT polypeptide, and a gene encoding an AROM polypeptide can produce vanillin and/or vanillin precursors in vivo.

In some embodiments, vanillin and vanillin precursors produced in vivo are produced by fermentation. In some aspects, the vanillin-producing strain was cultivated in an aerobic, glucose-limited, 5-day fed-batch process. This process included a ˜16 hour growth phase in the base medium which was primarily a minimal-defined medium with 4-8 wt % complex carbon source combined with glucose, followed by ˜100 hours of feeding with glucose utilized as the sole carbon and energy source. The glucose feed was combined with trace metals, vitamins, salts, a nitrogen source. The pH was kept near pH 5, the dissolved oxygen maintained above 20%, and the temperature setpoint was 30° C.

In some embodiments, vanillin and/or vanillin precursors are produced through contact of a vanillin precursor with one or more enzymes involved in the vanillin pathway in vitro. For example, contacting protocatechuic acid with an OMT polypeptide can result in production of vanillin in vitro. In some embodiments, a vanillin precursor is produced through contact of an upstream vanillin precursor with one or more enzymes involved in the vanillin pathway in vitro. For example, contacting dehydroshikimic acid with a 3DSD polypeptide can result in production of protocatechuic acid in vitro.

In some embodiments, vanillin or a vanillin precursor is produced by whole cell bioconversion. For whole cell bioconversion to occur, a host cell expressing one or more enzymes involved in the vanillin pathway takes up and modifies a vanillin precursor in the cell; following modification in vivo, vanillin remains in the cell and/or is excreted into the culture medium. For example, a host cell expressing a gene encoding an OMT polypeptide can take up protocatechuic acid and modify vanillin in the cell; following modification in vivo, vanillin is excreted into the culture medium or remains in the cell.

As used herein, the term “and/or” is utilized to describe multiple components in combination or exclusive of one another. For example, “x, y, and/or z” can refer to “x” alone, “y” alone, “z” alone, “x, y, and z,” “(x and y) or z,” “x and (y or z),” or “x or y or z.” In some embodiments, “and/or” is used to refer to the exogenous nucleic acids that a recombinant cell comprises, wherein a recombinant cell comprises one or more exogenous nucleic acids selected from a group. In some embodiments, “and/or” is used to refer to production of vanillin, vanillin is produced through one or more of the following steps: culturing a recombinant cell, synthesizing vanillin in a cell, and isolating vanillin.

### Vanillin Biosynthesis

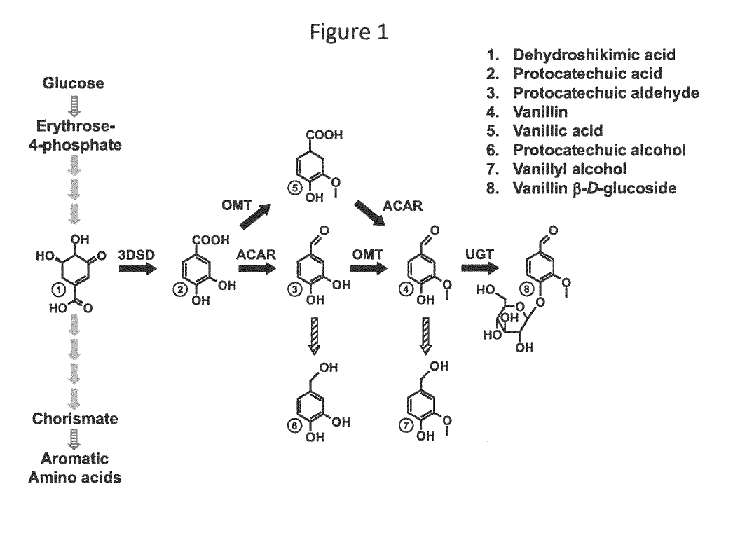

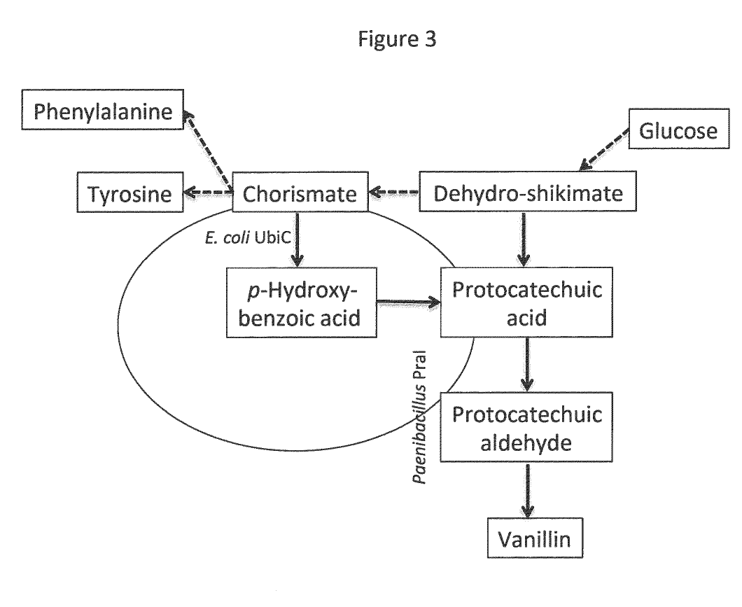

In some embodiments, vanillin is synthesized in a recombinant host. See e.g. Hansen et al., Appl. Environ. Microbiol. 75: 2765-2774 (2009) and PCT/US2012/049842, each of which is incorporated by reference in its entirety. In some embodiments, the invention involves (a) providing a recombinant host capable of producing vanillin, wherein said recombinant host harbors a heterologous nucleic acid encoding an Arom Multifunctional Enzyme (AROM) polypeptide and/or a Catechol-O-Methyl Transferase (COMT) polypeptide; (b) cultivating said recombinant host for a time sufficient for said recombinant host to produce vanillin; and (c) isolating vanillin from said recombinant host or from the cultivation supernatant, thereby producing vanillin. See e.g., PCT/US2012/049842, which is incorporated herein by reference in its entirety. In some embodiments, a recombinant host comprises a 3-dehydroshikimate dehydratase (3DSD), an aromatic carboxylic acid reductase (ACAR), and/or an O-methyltransferase (OMT). In some embodiments, the 3DSD comprises a Podospora pauciseta (P. pauciseta) 3DSD, the ACAR comprises a Nocardia ACAR, and the OMT comprises a Homo sapiens OMT. In some embodiments, a recombinant host comprises a phosphopantetheine transferase (PPTase) and/or a gene encoding a 4-(hydroxymethyl)-2-methoxyphenol alcohol oxidase (VAO). See FIGS. 1-3.

As used herein, the term “AROM polypeptide” as used herein refers to a polypeptide involved in a step of the shikimate pathway and has one or more of the following activities: 3-dehydroquinate synthase activity, 3-dehydroquinate dehydratase activity, shikimate 5-dehydrogenase activity, shikimate kinase activity, and 3-phosphoshikimate 1-carboxyvinyltransferase activity. Non-limiting examples of AROM polypeptides include the S. cerevisiae polypeptide having the amino acid sequence set forth in SEQ ID NO:4 (GENBANK Accession No. X06077); a Schizosaccharomyces pombe (S. pombe) polypeptide of GENBANK Accession No. NP_594681.1; a Schizosaccharomyces japonicas (S. japonicas) polypeptide of GENBANK Accession No. XP_002171624; a Neurospora crassa (N. crassa) polypeptide of GENBANK Accession No. XP_956000; and a Yarrowia lipolytica (Y. lipolytica) polypeptide of GENBANK Accession No. XP_505337.

In some embodiments, an AROM polypeptide can at least 80% (e.g., at least 85, 90, 95, 96, 97, 98, 99, or 100%) identical to the sequence set forth in SEQ ID NO:4 and possess at least four of the five enzymatic activities of the S. cerevisiae AROM polypeptide, i.e., 3-dehydroquinate synthase activity, 3-dehydroquinate dehydratase activity, shikimate 5-dehydrogenase activity, shikimate kinase activity, and 3-phosphoshikimate 1-carboxyvinyltransferase activity.

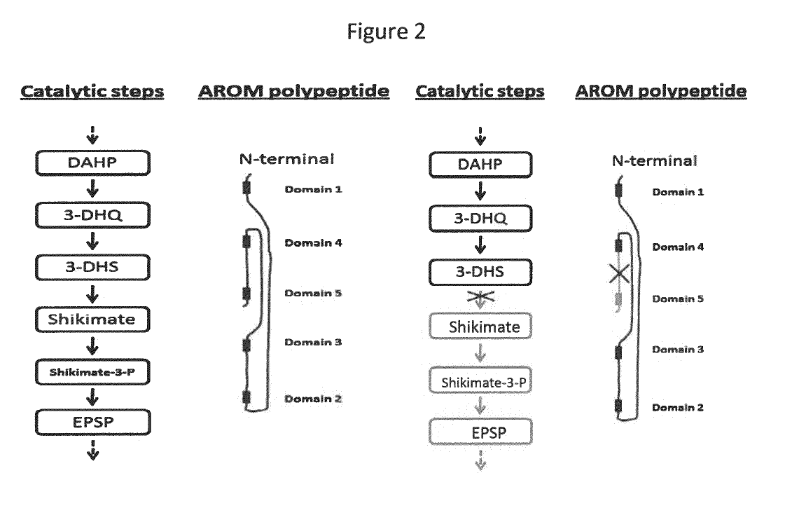

In some embodiments, a mutant AROM polypeptide is provided, wherein said mutant has decreased shikimate dehydrogenase activity relative to a corresponding wild-type AROM polypeptide. The mutant AROM polypeptide can have one or more mutations in domain 5, a deletion of at least a portion of domain 5, or lack domain 5. See FIG. 2.

According to one embodiment of this invention, the AROM polypeptide is a mutant AROM polypeptide with decreased shikimate dehydrogenase activity. When expressed in a recombinant host, the mutant AROM polypeptide redirects metabolic flux from aromatic amino acid production to vanillin precursor production (FIG. 2). Decreased shikimate dehydrogenase activity can be inferred from the accumulation of dehydroshikimic acid in a recombinant host expressing a mutant AROM polypeptide.

The mutant AROM polypeptide described herein can have one or more modifications in domain 5 (e.g., a substitution of one or more amino acids, a deletion of one or more amino acids, insertions of one or more amino acids, or combinations of substitutions, deletions, and insertions). In some embodiments, the AROM gene lacking domain 5 is the ARO1 gene. For example, a mutant AROM polypeptide can have a deletion in at least a portion of domain 5 (e.g., a deletion of the entire domain 5, i.e., amino acids 1305 to 1588 of the amino acid sequence in SEQ ID NO:4, or can have one or more amino acid substitutions in domain 5, such that the mutant AROM polypeptide has decreased shikimate dehydrogenase activity. An exemplary mutant AROM polypeptide lacking domain 5 is provided in SEQ ID NO:2 (corresponding nucleotide sequence set forth in SEQ ID NO:1).

Amino acid substitutions that are particularly useful can be found at, for example, one or more positions aligning with position 1349, 1366, 1370, 1387, 1392, 1441, 1458, 1500, 1533, or 1571 of the amino acid sequence set forth in SEQ ID NO:4. For example, a modified AROM polypeptide can have a substitution at a position aligning with position 1370 or at position 1392 of the amino acid sequence set forth in SEQ ID NO:4.

For example, a modified AROM polypeptide can have one or more of the following: an amino acid other than valine (e.g., a glycine) at a position aligning with position 1349 of the amino acid sequence set forth in SEQ ID NO:4; an amino acid other than threonine (e.g., a glycine) at a position aligning with position 1366 of the amino acid sequence set forth in SEQ ID NO:4; an amino acid other than lysine (e.g., leucine) at a position aligning with position 1370 of the amino acid sequence set forth in SEQ ID NO:4; an amino acid other than isoleucine (e.g., histidine) at a position aligning with position 1387 of the amino acid sequence set forth in SEQ ID NO:4; an amino acid other than threonine (e.g., lysine) at a position aligning with position 1392 of the amino acid sequence set forth in SEQ ID NO:4; an amino acid other than alanine (e.g., proline) at a position aligning with position 1441 of the amino acid sequence set forth in SEQ ID NO:4; an amino acid other than arginine (e.g., tryptophan) at a position aligning with position 1458 of the amino acid sequence set forth in SEQ ID NO:4; an amino acid other than proline (e.g., lysine) at a position aligning with position 1500 of the amino acid sequence set forth in SEQ ID NO:4; an amino acid other than alanine (e.g., proline) at a position aligning with position 1533 of the amino acid sequence set forth in SEQ ID NO:4; or an amino acid other than tryptophan (e.g., valine) at a position aligning with position 1571 of the amino acid sequence set forth in SEQ ID NO:4.

Exemplary mutant AROM polypeptides with at least one amino acid substitution in domain 5 include the AROM polypeptides A1533P, P1500K, R1458W, V1349G, T1366G, I1387H, W1571V, T1392K, K1370L and A1441P of SEQ ID NO:4.

In some embodiments, a modified AROM polypeptide is fused to a polypeptide catalyzing the first committed step of vanillin biosynthesis, 3-dehydroshikimate dehydratase (3DSD). A polypeptide having 3DSD activity and that is suitable for use in a fusion polypeptide includes the 3DSD polypeptide from P. pauciseta, Ustilago maydis (U. maydis), R. jostii), Acinetobacter sp., Aspergillus niger (A. niger), or N. crassa. See, GENBANK Accession Nos. CAD60599.1, XP_001905369.1, XP_761560.1, ABG93191.1, AAC37159.1, and XM_001392464.

For example, a modified AROM polypeptide lacking domain 5 can be fused to a polypeptide having 3DSD activity (e.g., a P. pauciseta 3DSD). SEQ ID NO:7 sets forth the amino acid sequence of such a protein.

The COMT polypeptide according to the invention may, in certain embodiments be a caffeoyl-O-methyltransferase. In other embodiments, the COMT polypeptide is preferably a catechol-O-methyltransferase. More preferably, a COMT polypeptide of the invention is a mutant COMT polypeptide having improved meta hydroxyl methylation of protocatechuic aldehyde, protocatechuic acid and/or protocatechuic alcohol relative to that of the Homo sapiens COMT having the amino acid sequence set forth in SEQ ID NO:8.

In some embodiments, a COMT polypeptide can be any amino acid sequence that is at least 80% (e.g., at least 85, 90, 95, 96, 97, 98, 99, or 100%) identical to the Homo sapiens COMT sequence set forth in SEQ ID NO:8 and possesses the catechol-O-methyltransferase enzymatic activities of the wild-type Homo sapiens COMT polypeptide.

In a further embodiment, a mutant COMT polypeptide is provided. In particular, the invention provides mutant COMT polypeptides that preferentially catalyze methylation at the meta position of protocatechuic acid, protocatechuic aldehyde, and/or protocatechuic alcohol rather than at the para position.

In one embodiment, the term “mutant COMT polypeptide,” as used herein, refers to any polypeptide having an amino acid sequence which is at least 80%, such as at least 85%, for example at least 90%, such as at least 95%, for example at least 96%, such as at least 97%, for example at least 98%, such as at least 99% identical to the Hs COMT sequence set forth in SEQ ID NO:8 and is capable of catalyzing methylation of the —OH group at the meta position of protocatechuic acid and/or protocatechuic aldehyde, wherein the amino acid sequence of said mutant COMT polypeptide differs from SEQ ID NO:8 by at least one amino acid. It is preferred that the mutant COMT polypeptide differs by at least one amino acid from any sequence of any wild type COMT polypeptide.

In another embodiment of the invention, the term “mutant COMT polypeptide” refers to a polypeptide having an amino acid sequence, which is at least 80%, such as at least 85%, for example at least 90%, such as at least 95%, for example at least 96%, such as at least 97%, for example at least 98%, such as at least 99% identical to either SEQ ID NO:9 or SEQ ID NO:10 and is capable of catalyzing methylation of the —OH group at the meta position of protocatechuic acid and/or protocatechuic aldehyde, wherein the amino acid sequence of said mutant COMT polypeptide differs from each of SEQ ID NO:9 and SEQ ID NO:10 by at least one amino acid.

The mutant COMT polypeptides described herein can have one or more mutations (e.g., a substitution of one or more amino acids, a deletion of one or more amino acids, insertions of one or more amino acids, or combinations of substitutions, deletions, and insertions) in, for example, the substrate binding site. For example, a mutant COMT polypeptide can have one or more amino acid substitutions in the substrate binding site of human COMT.

In certain embodiments, a “mutant COMT polypeptide” of the invention differs from SEQ ID NO:5, SEQ ID NO:9, SEQ ID NO:10 or SEQ ID NO:11 by one or two amino acid residues, wherein the differences between said mutant and wild-type proteins are in the substrate binding site.

The wild-type Homo sapiens COMT lacks regioselective O-methylation of protocatechuic aldehyde and protocatechuic acid, indicating that the binding site of Homo sapiens COMT does not bind these substrates in an orientation that allows the desired regioselective methylation. Without being bound to a particular mechanism, the active site of Homo sapiens COMT is composed of the co-enzyme S-adenosyl methionine (SAM), which serves as the methyl donor, and the catechol substrate, which contains the hydroxyl to be methylated coordinated to Mg²⁺ and proximal to Lys144. The O-methylation proceeds via an SN2 mechanism, where Lys144 serves as a catalytic base that deprotonates the proximal hydroxyl to form the oxy-anion that attacks a methyl group from the sulfonium of SAM. See, for example, Zheng & Bruice (1997) J. Am. Chem. Soc. 119 (35): 8137-45; Kuhn & Kollman (2000) J. Am. Chem. Soc. 122 (11): 2586-2596; Roca et al. (2003) J. Am. Chem. Soc. 125 (25):7726-37.

In one embodiment of the invention the invention provides a mutant COMT polypeptide, which is capable of catalyzing methylation of an —OH group of protocatechuic acid, wherein said methylation results in generation of at least 4 times more vanillic acid compared to iso-vanillic acid, preferably at least 5 times more vanillic acid compared to iso-vanillic acid, such as at least 10 times more vanillic acid compared to iso-vanillic acid, for example at least 15 times more vanillic acid compared to iso-vanillic acid, such as at least 20 times more vanillic acid compared to iso-vanillic acid, for example at least 25 times more vanillic acid compared to iso-vanillic acid, such as at least 30 times more vanillic acid compared to iso-vanillic acid; and which has an amino sequence which differs from SEQ ID NO:8 by at least one amino acid.

In addition to above mentioned properties, it is furthermore preferred that a mutant COMT polypeptide is capable of catalyzing methylation of an —OH group of protocatechuic aldehyde, wherein said methylation results in generation of at least 4, 5, 10, 15, 20, 25, or 30 times more vanillin compared to iso-vanillin; and/or is capable of catalyzing methylation of an —OH group of protocatechuic alcohol, wherein said methylation results in generation of at least 4, 5, 10, 15, 20, 25, or 30 times more 4-(hydroxymethyl)-2-methoxyphenol alcohol compared to iso-4-(hydroxymethyl)-2-methoxyphenol alcohol.

To determine whether a given mutant COMT polypeptide is capable of catalyzing methylation of an —OH group of protocatechuic acid, wherein said methylation results in generation of at least several times more vanillic acid compared to iso-vanillic acid, an in vitro assay can be conducted. In such an assay, protocatechuic acid is incubated with a mutant COMT polypeptide in the presence of a methyl donor and subsequently the level of generated iso-vanillic acid and vanillic acid is determined. Said methyl donor may for example be S-adenosylmethionine. More preferably, this may be determined by generating a recombinant host harboring a heterologous nucleic acid encoding the mutant COMT polypeptide to be tested, wherein said recombinant host furthermore is capable of producing protocatechuic acid. After cultivation of the recombinant host, the level of generated iso-vanillic acid and vanillic acid may be determined. In relation to this method it is preferred that said heterologous nucleic acid encoding the mutant COMT polypeptide to be tested is operably linked to a regulatory region allowing expression in said recombinant host. Furthermore, it is preferred that the recombinant host expresses at least one 3DSD and at least one ACAR, which preferably may be one of the 3DSDs and ACARs described herein. In embodiments where the recombinant host expresses an ACAR capable of catalyzing conversion of vanillic acid to vanillin, then the method may also include determining the level of generated vanillin and iso-vanillin. Alternatively, this may be determined by generating a recombinant host harboring a heterologous nucleic acid encoding the mutant COMT polypeptide to be tested, and feeding protocatechuic acid to said recombinant host, followed by determining the level of generated iso-vanillic acid and vanillic acid.

Similarly, an in vitro assay or a recombinant host cell can be used to determine whether a mutant COMT polypeptide is capable of catalyzing methylation of an —OH group of protocatechuic aldehyde, wherein said methylation results in generation of at least X times more vanillin compared to iso-vanillin. However, in this assay, protecatechuic aldehyde is used as starting material and the level of vanillin and iso-vanillin is determined.

Likewise, an in vitro assay or a recombinant host cell can be used to determine whether a given mutant COMT polypeptide is capable of catalyzing methylation of an —OH group of protocatechuic alcohol, wherein said methylation results in generation of at least X times more 4-(hydroxymethyl)-2-methoxyphenol alcohol compared to iso-4-(hydroxymethyl)-2-methoxyphenol alcohol. However, in this assay, protecatechuic alcohol is used as starting material and the level of 4-(hydroxymethyl)-2-methoxyphenol alcohol and iso-4-(hydroxymethyl)-2-methoxyphenol alcohol is determined.

The level of vanillin may be determined by any suitable method useful for detecting these compounds, wherein said method can distinguish between vanillin. Such methods include for example HPLC. Similarly, the level of iso-vanillic acid, vanillic acid, iso-4-(hydroxymethyl)-2-methoxyphenol alcohol and 4-(hydroxymethyl)-2-methoxyphenol alcohol may be determined using any suitable method useful for detecting these compounds, wherein said method can distinguish between vanillin. Such methods include for example HPLC.

In one embodiment, the invention provides a mutant COMT polypeptide, which (1) has an amino acid sequence sharing at least 80%, such as at least 85%, for example at least 90%, such as at least 95%, for example at least 96%, such as at least 97%, for example at least 98%, such as at least 99% sequence identity with SEQ ID NO:8 determined over the entire length of SEQ ID NO:8; and (2) has at least one amino acid substitution at a position aligning with positions 198 to 199 of SEQ ID NO:8, which may be any of the amino acid substitutions described herein below; and (3) is capable of catalyzing methylation of an —OH group of protocatechuic acid, wherein said methylation results in generation of at least 4, 5, 10, 15, 20, 25 or 30 times more vanillic acid compared to iso-vanillic acid. In addition these characteristics, said mutant COMT polypeptide may also be capable of catalyzing methylation of an —OH group of protocatechuic aldehyde, wherein said methylation results in generation of at least 4, 5, 10, 15, 20, 25 or 30 times more vanillin compared to iso-vanillin; and/or be capable of catalyzing methylation of an —OH group of protocatechuic alcohol, wherein said methylation results in generation of at least 4, 5, 10, 15, 20, 25, or 30 times more 4-(hydroxymethyl)-2-methoxyphenol alcohol compared to iso-4-(hydroxymethyl)-2-methoxyphenol alcohol.

Thus, the mutant COMT polypeptide may in one preferred embodiment have an amino acid substitution at the position aligning with position 198 of SEQ ID NO:8. Accordingly, the mutant COMT polypeptide may be a mutant COMT polypeptide with the characteristics outlined above, wherein said substitution is a substitution of the leucine at the position aligning with position 198 of SEQ ID NO:8 with another amino acid having a lower hydropathy index. For example, the mutant COMT polypeptide may be a mutant COMT polypeptide with characteristics as outlined above, wherein said substitution is a substitution of the leucine at the position aligning with position 198 of SEQ ID NO:8 with another amino acid having a hydropathy index lower than 2. Thus, the mutant COMT polypeptide may be a mutant COMT polypeptide with characteristics as outlined above, wherein said substitution is a substitution of the leucine at the position aligning with position 198 of SEQ ID NO:8 with an Ala, Arg, Asn, Asp, Cys, Glu, Gln, Gly, His, Lys, Met, Phe, Pro, Ser, Thr, Trp or Tyr, for example Ala, Arg, Asn, Asp, Glu, Gln, Gly, His, Lys, Met, Pro, Ser, Thr, Trp or Tyr. However, preferably said substitution is a substitution of the leucine at the position aligning with position 198 of SEQ ID NO:8 with tyrosine. Substitution of the leucine aligning with position 198 of SEQ ID NO:8 with methionine increased regioselectivity of meta>para O-methylation for protocatechuic aldehyde.

In another preferred embodiment, the mutant COMT polypeptide may have an amino acid substitution at the position aligning with position 199 of SEQ ID NO:8. Accordingly, the mutant COMT polypeptide may be a mutant COMT polypeptide with characteristics as outlined above, wherein said substitution is a substitution of the glutamic acid at the position aligning with position 199 of SEQ ID NO:8 with another amino acid, which has either a neutral or positive side-chain charge at pH 7.4. Thus, the mutant COMT polypeptide may be a mutant COMT polypeptide with characteristics as outlined above, wherein said substitution is a substitution of the glutamic acid at the position aligning with position 199 of SEQ ID NO:8 with Ala, Arg, Asn, Cys, Gln, Gly, His, Ile, Leu, Lys, Met, Phe, Pro, Ser, Thr, Trp, Tyr or Val. However, preferably said substitution is a substitution of the glutamic acid at the position aligning with position 199 of SEQ ID NO:8 with an alanine or glutamine. Substitution of the glutamic acid aligning with position 199 of SEQ ID NO:8 with alanine or glutamine increased regioselectivity of meta>para O-methylation for protocatechuic aldehyde.

For example, a mutant COMT polypeptide can have one or more of the following mutations: a substitution of a tryptophan, tyrosine, phenylalanine, glutamic acid, or arginine for the leucine at a position aligning with position 198 of the amino acid sequence set forth in SEQ ID NO:8; a substitution of an arginine, lysine, or alanine for methionine at a position aligning with position 40 of the amino acid sequence set forth in SEQ ID NO:8; a substitution of a tyrosine, lysine, histidine, or arginine for the tryptophan at a position aligning with position 143 of the amino acid sequence set forth in SEQ ID NO:8; a substitution of an isoleucine, arginine, or tyrosine for the proline at a position aligning with position 174 of the amino acid sequence set forth in SEQ ID NO:8; a substitution of an arginine or lysine for tryptophan at a position aligning with position 38 of the amino acid sequence set forth in SEQ ID NO:8; a substitution of a phenylalanine, tyrosine, glutamic acid, tryptophan, or methionine for cysteine at a position aligning with position 173 of the amino acid sequence set forth in SEQ ID NO:8; and/or a substitution of a serine, glutamic acid, or aspartic acid for arginine at a position aligning with position 201 of the amino acid sequence set forth in SEQ ID NO:8.

In one embodiment, a mutant COMT polypeptide contains substitution of tryptophan for leucine at a position aligning with position 198. This mutation may increase regioselectivity of meta>para O-methylation for protocatechuic acid. Modeling of the protein binding site of a COMT polypeptide containing a L198W mutation, indicates that a steric clash can occur between the mutated residue and the substrate. This steric clash does not occur in the meta reacting conformation as the carboxylic acid of the substrate is distal to this residue.

In another embodiment of the invention, the mutant COMT polypeptide is a polypeptide of SEQ ID NO:8, wherein the amino acid at position 198 has been substituted with an amino acid having a lower hydropathy index than leucine. For example, the mutant COMT polypeptide may be a polypeptide of SEQ ID NO:8, wherein the leucine at the position 198 has been substituted with an amino acid having a hydropathy index lower than 2. Thus, the mutant COMT polypeptide may be a polypeptide of SEQ ID NO:8, wherein the leucine at position 198 has been substituted with an Ala, Arg, Asn, Asp, Glu, Gln, Gly, His, Lys, Met, Pro, Ser, Thr, Trp or Tyr, preferably Met or Tyr.

In another preferred embodiment, the mutant COMT polypeptide may be a polypeptide of SEQ ID NO:8, wherein the amino acid at position 199 has been substituted with another amino acid, which has either a neutral or positive side-chain charge at pH 7.4. Thus, the mutant COMT polypeptide may be a polypeptide of SEQ ID NO:8 where the glutamic acid at the position 199 has been substituted with Ala, Arg, Asn, Cys, Gln, Gly, His, Ile, Leu, Lys, Met, Phe, Pro, Ser, Thr, Trp, Tyr or Val, preferably Ala or Gin.

In some embodiments, a mutant COMT polypeptide has two or more mutations. For example, 2, 3, 4, 5, 6, or 7 of the residues in the substrate binding site can be mutated. For example, in one embodiment, a mutant COMT polypeptide can have a substitution of an arginine or lysine for methionine at a position aligning with position 40 of the amino acid sequence of SEQ ID NO:8; a substitution of a tyrosine or histidine for tryptophan at a position aligning with position 143 of the amino acid sequence of SEQ ID NO:8; a substitution of an isoleucine for proline at a position aligning with position 174 of the amino acid sequence of SEQ ID NO:8, and a substitution of an arginine or lysine for tryptophan at position 38. A mutant COMT polypeptide also can have a substitution of lysine or arginine for tryptophan at a position aligning with position 143 of the amino acid sequence of SEQ ID NO:8 and a substitution of an arginine or tyrosine for proline at position 174 of SEQ ID NO:8. A mutant COMT polypeptide also can have a substitution of a phenylalanine, tyrosine, glutamic acid, tryptophan, or methionine for cysteine at a position aligning with position 173 of the amino acid sequence set forth in SEQ ID NO:8, a substitution of an alanine for methionine at a position aligning with position 40 of the amino acid sequence set forth in SEQ ID NO:8, and a substitution of a serine, glutamic acid, or aspartic acid for the arginine at a position aligning with position 201 of the amino acid sequence set forth in SEQ ID NO:8. It is also possible that the mutant COMT polypeptide has a substitution of the leucine at a position aligning with position 198 of SEQ ID NO:8 as well as a substitution of the glutamic acid at a position aligning with position 199 of SEQ ID NO:8. Said substitutions may be any of the substitutions described in this section above, It is also possible that the mutant COMT polypeptide has a substitution of the leucine at a position aligning with position 198 of SEQ ID NO:8 as well as a substitution of the arginine at a position aligning with position 201 of SEQ ID NO:8. Said substitutions may be any of the substitutions described in this section above.

Accordingly, the invention provides mutant AROM and mutant COMT polypeptides and nucleic acids encoding such polypeptides and use of the same in the biosynthesis of vanillin. The method includes the steps of providing a recombinant host capable of producing vanillin in the presence of a carbon source, wherein said recombinant host harbors a heterologous nucleic acid encoding a mutant COMT polypeptide and/or mutant AROM polypeptide; cultivating said recombinant host in the presence of the carbon source; and purifying vanillin isolating vanillin from said recombinant host or from the cultivation supernatant.

Suitable 3DSD polypeptides are known. A 3DSD polypeptide according to the present invention may be any enzyme with 3-dehydroshikimate dehydratase activity. Preferably, the 3DSD polypeptide is an enzyme capable of catalyzing conversion of 3-dehydro-shikimate to protocatechuate and H₂O. A 3DSD polypeptide according to the present invention is preferably an enzyme classified under EC 4.2.1.118. For example, a suitable polypeptide having 3DSD activity includes the 3DSD polypeptide made by P. pauciseta, U. maydis, R. jostii, Acinetobacter sp., A. niger or N. crassa. See, GENBANK Accession Nos CAD60599, XP_001905369.1, XP_761560.1, ABG93191.1, AAC37159.1, and XM_001392464. Thus, the recombinant host may include a heterologous nucleic acid encoding the 3DSD polypeptide of Podospora anserina (P. anserina), U. maydis, R. jostii, Acinetobacter sp., A. niger or N. crassa or a functional homologue of any of the aforementioned sharing at least 80%, such as at least 85%, for example at least 90%, such as at least 95%, for example at least 98% sequence identity therewith.

As discussed herein, suitable wild-type OMT polypeptides are known. For example, a suitable wild-type OMT polypeptide includes the OMT made by H. sapiens, A. thaliana, or Fragaria x ananassa (see GENBANK Accession Nos. NM_000754, AY062837; and AF220491), as well as OMT polypeptides isolated from a variety of other mammals, plants or microorganisms.

Suitable ACAR polypeptides are known. An ACAR polypeptide according to the present invention may be any enzyme having aromatic carboxylic acid reductase activity. Preferably, the ACAR polypeptide is an enzyme capable of catalyzing conversion protocatechuic acid to protocatechuic aldehyde and/or conversion of vanillic acid to vanillin. An ACAR polypeptide according to the present invention is preferably an enzyme classified under EC 1.2.1.30. For example a suitable ACAR polypeptide is made by Nocardia sp. See, e.g., GENBANK Accession No. AY495697. Thus, the recombinant host may include a heterologous nucleic acid encoding the ACAR polypeptide of Nocardia sp. or a functional homologue thereof sharing at least 80%, such as at least 85%, for example at least 90%, such as at least 95%, for example at least 98% sequence identity therewith.

Suitable PPTase polypeptides are known. A PPTase polypeptide according to the present invention may be any enzyme capable of catalyzing phosphopantetheinylation. Preferably, the PPTase polypeptide is an enzyme capable of catalyzing phosphopantetheinylation of ACAR. For example, a suitable PPTase polypeptide is made by E. coli, Corynebacterium glutamicum (C. glutamicum), or Nocardia farcinica (N. farcinica). See GENBANK Accession Nos. NP_601186, BAA35224, and YP_120266. Thus, the recombinant host may include a heterologous nucleic acid encoding the PPTase polypeptide of E. coli, C. glutamicum, or N. farcinica or a functional homologue of any of the aforementioned sharing at least 80%, such as at least 85%, for example at least 90%, such as at least 95%, for example at least 98% sequence identity therewith.

As a further embodiment of this invention, a 4-(hydroxymethyl)-2-methoxyphenol alcohol oxidase (VAO) enzyme (EC 1.1.3.38) can also be expressed by host cells to oxidize any formed 4-(hydroxymethyl)-2-methoxyphenol alcohol into vanillin. VAO enzymes are known in the art and include, but are not limited to enzymes from filamentous fungi such as Fusarium onilifomis (F. onilifomis; GENBANK Accession No. AFJ11909) and P. simplicissium (GENBANK Accession No. P56216; Benen, et al. (1998) J. Biol. Chem. 273:7865-72) and bacteria such as Modestobacter marinus (M. marinus; GENBANK Accession No. YP_006366868), R. jostii (GENBANK Accession No. YP_703243.1) and R. opacus (GENBANK Accession No. EH139392).

In some cases, it is desirable to inhibit one or more functions of an endogenous polypeptide in order to divert metabolic intermediates toward biosynthesis. For example, pyruvate decarboxylase (PDC1) and/or glutamate dehydrogenase activity can be reduced. In such cases, a nucleic acid that inhibits expression of the polypeptide or gene product may be included in a recombinant construct that is transformed into the strain. Alternatively, mutagenesis can be used to generate mutants in genes for which it is desired to inhibit function.

### Functional Homologs

Functional homologs of the polypeptides described above are also suitable for use in producing vanillin in a recombinant host. A functional homolog is a polypeptide that has sequence similarity to a reference polypeptide, and that carries out one or more of the biochemical or physiological function(s) of the reference polypeptide. A functional homolog and the reference polypeptide can be natural occurring polypeptides, and the sequence similarity can be due to convergent or divergent evolutionary events. As such, functional homologs are sometimes designated in the literature as homologs, or orthologs, or paralogs. Variants of a naturally occurring functional homolog, such as polypeptides encoded by mutants of a wild type coding sequence, can themselves be functional homologs. Functional homologs can also be created via site-directed mutagenesis of the coding sequence for a polypeptide, or by combining domains from the coding sequences for different naturally-occurring polypeptides (“domain swapping”). Techniques for modifying genes encoding functional polypeptides described herein are known and include, inter alia, directed evolution techniques, site-directed mutagenesis techniques and random mutagenesis techniques, and can be useful to increase specific activity of a polypeptide, alter substrate specificity, alter expression levels, alter subcellular location, or modify polypeptide:polypeptide interactions in a desired manner. Such modified polypeptides are considered functional homologs. The term “functional homolog” is sometimes applied to the nucleic acid that encodes a functionally homologous polypeptide.

Functional homologs can be identified by analysis of nucleotide and polypeptide sequence alignments. For example, performing a query on a database of nucleotide or polypeptide sequences can identify homologs of vanillin biosynthesis polypeptides. Sequence analysis can involve BLAST, Reciprocal BLAST, or PSI-BLAST analysis of nonredundant databases using a COMT, AROM, 3DSD, ACAR, VAO, OMT, or PPTase amino acid sequence as the reference sequence. Amino acid sequence is, in some instances, deduced from the nucleotide sequence. Those polypeptides in the database that have greater than 40% sequence identity are candidates for further evaluation for suitability as a vanillin biosynthesis polypeptide. Amino acid sequence similarity allows for conservative amino acid substitutions, such as substitution of one hydrophobic residue for another or substitution of one polar residue for another. If desired, manual inspection of such candidates can be carried out in order to narrow the number of candidates to be further evaluated. Manual inspection can be performed by selecting those candidates that appear to have domains present in vanillin biosynthesis polypeptides, e.g., conserved functional domains.

Conserved regions can be identified by locating a region within the primary amino acid sequence of a vanillin biosynthesis polypeptide that is a repeated sequence, forms some secondary structure (e.g., helices and beta sheets), establishes positively or negatively charged domains, or represents a protein motif or domain. See, e.g., the Pfam web site describing consensus sequences for a variety of protein motifs and domains on the World Wide Web at sanger.ac.uk/Software/Pfam/ and pfam.janelia.org/. The information included at the Pfam database is described in Sonnhammer et al., Nucl. Acids Res., 26:320-322 (1998); Sonnhammer et al., Proteins, 28:405-420 (1997); and Bateman et al., Nucl. Acids Res., 27:260-262 (1999). Conserved regions also can be determined by aligning sequences of the same or related polypeptides from closely related species. Closely related species preferably are from the same family. In some embodiments, alignment of sequences from two different species is adequate.

Typically, polypeptides that exhibit at least about 40% amino acid sequence identity are useful to identify conserved regions. Conserved regions of related polypeptides exhibit at least 45% amino acid sequence identity (e.g., at least 50%, at least 60%, at least 70%, at least 80%, or at least 90% amino acid sequence identity). In some embodiments, a conserved region exhibits at least 92%, 94%, 96%, 98%, or 99% amino acid sequence identity.

For example, polypeptides suitable for producing vanillin in a recombinant host include functional homologs of COMT, AROM, 3DSD, ACAR, VAO, OMT, or PPTase.

Methods to modify the substrate specificity of, for example, COMT, AROM, 3DSD, ACAR, VAO, OMT, or PPTase, are known to those skilled in the art, and include without limitation site-directed/rational mutagenesis approaches, random directed evolution approaches and combinations in which random mutagenesis/saturation techniques are performed near the active site of the enzyme. For example see Osmani et al., Phytochemistry 70 (2009) 325-347.

A candidate sequence typically has a length that is from 80% to 200% of the length of the reference sequence, e.g., 82, 85, 87, 89, 90, 93, 95, 97, 99, 100, 105, 110, 115, 120, 130, 140, 150, 160, 170, 180, 190, or 200% of the length of the reference sequence. A functional homolog polypeptide typically has a length that is from 95% to 105% of the length of the reference sequence, e.g., 90, 93, 95, 97, 99, 100, 105, 110, 115, or 120% of the length of the reference sequence, or any range between. A % identity for any candidate nucleic acid or polypeptide relative to a reference nucleic acid or polypeptide can be determined as follows. A reference sequence (e.g., a nucleic acid sequence or an amino acid sequence described herein) is aligned to one or more candidate sequences using the computer program ClustalW (version 1.83, default parameters), which allows alignments of nucleic acid or polypeptide sequences to be carried out across their entire length (global alignment). Chenna et al., Nucleic Acids Res., 31(13):3497-500 (2003).

ClustalW calculates the best match between a reference and one or more candidate sequences, and aligns them so that identities, similarities and differences can be determined. Gaps of one or more residues can be inserted into a reference sequence, a candidate sequence, or both, to maximize sequence alignments. For fast pairwise alignment of nucleic acid sequences, the following default parameters are used: word size: 2; window size: 4; scoring method: % age; number of top diagonals: 4; and gap penalty: 5. For multiple alignment of nucleic acid sequences, the following parameters are used: gap opening penalty: 10.0; gap extension penalty: 5.0; and weight transitions: yes. For fast pairwise alignment of protein sequences, the following parameters are used: word size: 1; window size: 5; scoring method:% age; number of top diagonals: 5; gap penalty: 3. For multiple alignment of protein sequences, the following parameters are used: weight matrix: blosum; gap opening penalty: 10.0; gap extension penalty: 0.05; hydrophilic gaps: on; hydrophilic residues: Gly, Pro, Ser, Asn, Asp, Gln, Glu, Arg, and Lys; residue-specific gap penalties: on. The ClustalW output is a sequence alignment that reflects the relationship between sequences. ClustalW can be run, for example, at the Baylor College of Medicine Search Launcher site on the World Wide Web (searchlauncher.bcm.tmc.edu/multi-align/multi-align.html) and at the European Bioinformatics Institute site on the World Wide Web (ebi.ac.uk/clustalw).

To determine %-identity of a candidate nucleic acid or amino acid sequence to a reference sequence, the sequences are aligned using ClustalW, the number of identical matches in the alignment is divided by the length of the reference sequence, and the result is multiplied by 100. It is noted that the % identity value can be rounded to the nearest tenth. For example, 78.11, 78.12, 78.13, and 78.14 are rounded down to 78.1, while 78.15, 78.16, 78.17, 78.18, and 78.19 are rounded up to 78.2.

It will be appreciated that functional COMT, AROM, 3DSD, ACAR, VAO, OMT, or PPTase can include additional amino acids that are not involved in glucosylation or other enzymatic activities carried out by the enzyme, and thus such a polypeptide can be longer than would otherwise be the case.

### Vanillin Biosynthesis Nucleic Acids

A recombinant gene encoding a polypeptide described herein comprises the coding sequence for that polypeptide, operably linked in sense orientation to one or more regulatory regions suitable for expressing the polypeptide. Because many microorganisms are capable of expressing multiple gene products from a polycistronic mRNA, multiple polypeptides can be expressed under the control of a single regulatory region for those microorganisms, if desired. A coding sequence and a regulatory region are considered to be operably linked when the regulatory region and coding sequence are positioned so that the regulatory region is effective for regulating transcription or translation of the sequence. Typically, the translation initiation site of the translational reading frame of the coding sequence is positioned between one and about fifty nucleotides downstream of the regulatory region for a monocistronic gene.

In many cases, the coding sequence for a polypeptide described herein is identified in a species other than the recombinant host, i.e., is a heterologous nucleic acid. Thus, if the recombinant host is a microorganism, the coding sequence can be from other prokaryotic or eukaryotic microorganisms, from plants or from animals. In some case, however, the coding sequence is a sequence that is native to the host and is being reintroduced into that organism. A native sequence can often be distinguished from the naturally occurring sequence by the presence of non-natural sequences linked to the exogenous nucleic acid, e.g., non-native regulatory sequences flanking a native sequence in a recombinant nucleic acid construct. In addition, stably transformed exogenous nucleic acids typically are integrated at positions other than the position where the native sequence is found.

“Regulatory region” refers to a nucleic acid having nucleotide sequences that influence transcription or translation initiation and rate, and stability and/or mobility of a transcription or translation product. Regulatory regions include, without limitation, promoter sequences, enhancer sequences, response elements, protein recognition sites, inducible elements, protein binding sequences, 5′ and 3′ untranslated regions (UTRs), transcriptional start sites, termination sequences, polyadenylation sequences, introns, and combinations thereof. A regulatory region typically comprises at least a core (basal) promoter. A regulatory region also can include at least one control element, such as an enhancer sequence, an upstream element or an upstream activation region (UAR). A regulatory region is operably linked to a coding sequence by positioning the regulatory region and the coding sequence so that the regulatory region is effective for regulating transcription or translation of the sequence. For example, to operably link a coding sequence and a promoter sequence, the translation initiation site of the translational reading frame of the coding sequence is typically positioned between one and about fifty nucleotides downstream of the promoter. A regulatory region can, however, be positioned as much as about 5,000 nucleotides upstream of the translation initiation site, or about 2,000 nucleotides upstream of the transcription start site.

The choice of regulatory regions to be included depends upon several factors, including, but not limited to, efficiency, selectability, inducibility, desired expression level, and preferential expression during certain culture stages. It is a routine matter for one of skill in the art to modulate the expression of a coding sequence by appropriately selecting and positioning regulatory regions relative to the coding sequence. It will be understood that more than one regulatory region can be present, e.g., introns, enhancers, upstream activation regions, transcription terminators, and inducible elements.

One or more genes can be combined in a recombinant nucleic acid construct in “modules” useful for a discrete aspect of vanillin production. Combining a plurality of genes in a module, particularly a polycistronic module, facilitates the use of the module in a variety of species.

It will be appreciated that because of the degeneracy of the genetic code, a number of nucleic acids can encode a particular polypeptide; i.e., for many amino acids, there is more than one nucleotide triplet that serves as the codon for the amino acid. Thus, codons in the coding sequence for a given polypeptide can be modified such that optimal expression in a particular host is obtained, using appropriate codon bias tables for that host (e.g., microorganism). As isolated nucleic acids, these modified sequences can exist as purified molecules and can be incorporated into a vector or a virus for use in constructing modules for recombinant nucleic acid constructs.

In some cases, it is desirable to inhibit one or more functions of an endogenous polypeptide in order to divert metabolic intermediates towards vanillin biosynthesis. For example, it can be desirable to downregulate synthesis of sterols in a yeast strain in order to further increase vanillin production, e.g., by downregulating squalene epoxidase. As another example, it can be desirable to inhibit degradative functions of certain endogenous gene products, e.g., glycohydrolases that remove glucose moieties from secondary metabolites or phosphatases as discussed herein. As another example, expression of membrane transporters involved in transport of vanillin can be inhibited, such that secretion of glycosylated vanillin is inhibited. Such regulation can be beneficial in that secretion of vanillin can be inhibited for a desired period of time during culture of the microorganism, thereby increasing the yield of glucoside product(s) at harvest. In such cases, a nucleic acid that inhibits expression of the polypeptide or gene product can be included in a recombinant construct that is transformed into the strain. Alternatively, mutagenesis can be used to generate mutants in genes for which it is desired to inhibit function.

### Microorganisms

Recombinant hosts can be used to express polypeptides for the production of vanillin, including mammalian, insect, and plant cells. A number of prokaryotes and eukaryotes are also suitable for use in constructing the recombinant microorganisms described herein, e.g., gram-negative bacteria, yeast and fungi. A species and strain selected for use as a vanillin production strain is first analyzed to determine which production genes are endogenous to the strain and which genes are not present. Genes for which an endogenous counterpart is not present in the strain are assembled in one or more recombinant constructs, which are then transformed into the strain in order to supply the missing function(s).

Exemplary prokaryotic and eukaryotic species are described in more detail below. However, it will be appreciated that other species can be suitable. For example, suitable species can be in a genus such as Agaricus, Aspergillus, Bacillus, Candida, Corynebacterium, Eremothecium, Escherichia, Fusarium/Gibberella, Kluyveromyces, Laetiporus, Lentinus, Phaffia, Phanerochaete, Pichia, Physcomitrella, Rhodoturula, Saccharomyces, Schizosaccharomyces, Sphaceloma, Xanthophyllomyces or Yarrowia. Exemplary species from such genera include Lentinus tigrinus, Laetiporus sulphureus, Phanerochaete chrysosporium, Pichia pastoris, Cyberlindnera jadinii, Physcomitrella patens, Rhodoturula glutinis 32, Rhodoturula mucilaginosa, Phaffia rhodozyma UBV-AX, Xanthophyllomyces dendrorhous, Fusarium fujikuroi/Gibberella fujikuroi, Candida utilis, Candida glabrata, Candida albicans, C. glutamicum, and Y. lipolytica. In some embodiments, a microorganism can be an Ascomycete such as Gibberella fujikuroi, Kluyveromyces lactis, S. pombe, A. niger, Y. lipolytica, Ashbya gossypii, or S. cerevisiae. In some embodiments, a microorganism can be a prokaryote such as, for example but not limiting to, E. coli (see e.g., Zhang et al., J Ind Microbiol Biotechnol. 2013 June; 40(6):643-51), C. glutamicum, Rhodobacter sphaeroides, or Rhodobacter capsulatus. It will be appreciated that certain microorganisms can be used to screen and test genes of interest in a high throughput manner, while other microorganisms with desired productivity or growth characteristics can be used for large-scale production of vanillin.

S. cerevisiae

S. cerevisiae is a widely used chassis organism in synthetic biology, and can be used as the recombinant microorganism platform. There are libraries of mutants, plasmids, detailed computer models of metabolism and other information available for S. cerevisiae, allowing for rational design of various modules to enhance product yield. Methods are known for making recombinant microorganisms.

A vanillin biosynthesis gene cluster can be expressed in yeast using any of a number of known promoters.

### Aspergillus spp.

Aspergillus species such as A. oryzae, A. niger and A. sojae are widely used microorganisms in food production, and can also be used as the recombinant microorganism platform. Nucleotide sequences are available for genomes of A. nidulans, A. fumigatus, A. oryzae, A. clavatus, A. flavus, A. niger, and A. terreus, allowing rational design and modification of endogenous pathways to enhance flux and increase product yield. Metabolic models have been developed for Aspergillus, as well as transcriptomic studies and proteomics studies. A. niger is cultured for the industrial production of a number of food ingredients such as citric acid and gluconic acid, and thus species such as A. niger are generally suitable for the production of food ingredients such as vanillin.

E. coli

E. coli, another widely used platform organism in synthetic biology, can also be used as the recombinant microorganism platform. Similar to Saccharomyces, there are libraries of mutants, plasmids, detailed computer models of metabolism and other information available for E. coli, allowing for rational design of various modules to enhance product yield. Methods similar to those described above for Saccharomyces can be used to make recombinant E. coli microorganisms.

### Agaricus, Gibberella, and Phanerochaete spp.

Agaricus, Gibberella, and Phanerochaete spp. can be useful because they are known to produce large amounts of gibberellin in culture. Thus, the vanillin precursors for producing large amounts of vanillin are already produced by endogenous genes. Thus, modules containing recombinant genes for vanillin biosynthesis polypeptides can be introduced into species from such genera without the necessity of introducing mevalonate or MEP pathway genes.

Arxula adeninivorans (Blastobotrys adeninivorans)

Arxula adeninivorans is a dimorphic yeast (it grows as a budding yeast like the baker's yeast up to a temperature of 42° C., above this threshold it grows in a filamentous form) with unusual biochemical characteristics. It can grow on a wide range of substrates and can assimilate nitrate. It has successfully been applied to the generation of strains that can produce natural plastics or the development of a biosensor for estrogens in environmental samples.

Y. lipolytica

Y. lipolytica is a dimorphic yeast (see Arxula adeninivorans) that can grow on a wide range of substrates. It has a high potential for industrial applications.

Candida boidinii

Candida boidinii is a methylotrophic yeast (it can grow on methanol). Like other methylotrophic species such as Hansenula polymorpha and Pichia pastoris, it provides an excellent platform for the production of heterologous proteins. Yields in a multigram range of a secreted foreign protein have been reported. A computational method, IPRO, recently predicted mutations that experimentally switched the cofactor specificity of Candida boidinii xylose reductase from NADPH to NADH.

Hansenula polymorpha (Pichia angusta)

Hansenula polymorpha is another methylotrophic yeast (see Candida boidinii). It can furthermore grow on a wide range of other substrates; it is thermo-tolerant and can assimilate nitrate (see also Kluyveromyces lactis). It has been applied to the production of hepatitis B vaccines, insulin and interferon alpha-2a for the treatment of hepatitis C, furthermore to a range of technical enzymes.

Kluyveromyces lactis

Kluyveromyces lactis is yeast regularly applied to the production of kefir. It can grow on several sugars, most importantly on lactose which is present in milk and whey. It has successfully been applied among others to the production of chymosin (an enzyme that is usually present in the stomach of calves) for the production of cheese. Production takes place in fermenters on a 40,000 L scale.

Pichia pastoris

Pichia pastoris is a methylotrophic yeast (see Candida boidinii and Hansenula polymorpha). It provides an efficient platform for the production of foreign proteins. Platform elements are available as a kit and it is worldwide used in academia for the production of proteins. Strains have been engineered that can produce complex human N-glycan (yeast glycans are similar but not identical to those found in humans).

### Physcomitrella spp.

Physcomitrella mosses, when grown in suspension culture, have characteristics similar to yeast or other fungal cultures. This genera is becoming an important type of cell for production of plant secondary metabolites, which can be difficult to produce in other types of cells.

Carbon sources of use in the instant method include any molecule that can be metabolized by the recombinant host cell to facilitate growth and/or production of the vanillin. Examples of suitable carbon sources include, but are not limited to, sucrose (e.g., as found in molasses), fructose, xylose, ethanol, glycerol, glucose, cellulose, starch, cellobiose or other glucose containing polymer. In embodiments employing yeast as a host, for example, carbons sources such as sucrose, fructose, xylose, ethanol, glycerol, and glucose are suitable. The carbon source can be provided to the host organism throughout the cultivation period or alternatively, the organism can be grown for a period of time in the presence of another energy source, e.g., protein, and then provided with a source of carbon only during the fed-batch phase.

### Methods of Producing Vanillin

Recombinant hosts described herein can be used in methods to produce vanillin. For example, if the recombinant host is a microorganism, the method can include growing the recombinant microorganism in a culture medium under conditions in which vanillin biosynthesis genes are expressed. The recombinant microorganism can be grown in a fed batch or continuous process. Typically, the recombinant microorganism is grown in a fermentor at a defined temperature(s) for a desired period of time. In certain embodiments, microorganisms include, but are not limited to S. cerevisiae, A. niger, A. oryzae, E. coli, L. lactis and B. subtilis. The constructed and genetically engineered microorganisms provided by the invention can be cultivated using conventional fermentation processes, including, inter alia, chemostat, batch, fed-batch cultivations, continuous perfusion fermentation, and continuous perfusion cell culture.

Depending on the particular microorganism used in the method, other recombinant genes can also be present and expressed. Levels of substrates, intermediates and side products, e.g., dehydroshikimic acid, protocatechuic acid, protocatechuic aldehyde, vanillic acid, protocatechuic alcohol, 4-(hydroxymethyl)-2-methoxyphenol alcohol, vanillin β-D-glucoside can be determined by extracting samples from culture medium for analysis according to published methods.

After the recombinant microorganism has been grown in culture for the desired period of time, vanillin can then be recovered from the culture using various techniques known in the art. In some embodiments, a permeabilizing agent can be added to aid the feedstock entering into the host and product getting out. If the recombinant host is a plant or plant cells, vanillin can be extracted from the plant tissue using various techniques known in the art. For example, a crude lysate of the cultured microorganism or plant tissue can be centrifuged to obtain a supernatant. The resulting supernatant can then be applied to a chromatography column, e.g., a C18 column such as Aqua® C18 column from Phenomenex or a Synergi™ Hydro RP 80 Å column, and washed with water to remove hydrophilic compounds, followed by elution of the compound(s) of interest with a solvent such as acetonitrile or methanol. The compound(s) can then be further purified by preparative HPLC. See also WO 2009/140394, which is incorporated by reference in its entirety.

In some embodiments, vanillin can be produced using whole cells that are fed raw materials that contain precursor molecules. The raw materials may be fed during cell growth or after cell growth. The whole cells may be in suspension or immobilized. The whole cells may be in fermentation broth or in a reaction buffer. In some embodiments a permeabilizing agent may be required for efficient transfer of substrate into the cells.

It will be appreciated that the various genes and modules discussed herein can be present in two or more recombinant microorganisms rather than a single microorganism. When a plurality of recombinant microorganisms is used, they can be grown in a mixed culture to produce vanillin. For example, a first microorganism can comprise one or more biosynthesis genes for producing vanillin while a second microorganism comprises one or more vanillin biosynthesis genes. It will also be appreciated that in some embodiments, a recombinant microorganism is grown using nutrient sources other than a culture medium and utilizing a system other than a fermentor.

### Methods of Purifying Vanillin

After the recombinant microorganism has been grown in culture for the desired period of time, vanillin can then be recovered from the culture using various technigues known in the art, e.g., isolation and purification by extraction, vacuum distillation and multi-stage re-crystallization from aqueous solutions and ultrafiltration (Boddeker, et al. (1997) J. Membrane Sci. 137:155-8; Borges da Silva, et al. (2009) Chem. Eng. Des. 87:1276-92). Two-phase extraction processes, employing either sulphydryl compounds, such as dithiothreitol, dithioerythritol, glutathione, or L-cysteine (U.S. Pat. No. 5,128,253), or alkaline KOH solutions (WO 1994/013614), have been used in the recovery of vanillin as well as for its separation from other aromatic substances. Vanillin adsorption and pervaporation from bioconverted media using polyether-polyamide copolymer membranes has also been described (Boddeker, et al. (1997) supra; Zucchi, et al. (1998) J. Microbiol. Biotechnol. 8:719-22). Macroporous adsorption resins with crosslinked-polystyrene framework have also been used to recover dissolved vanillin from aqueous solutions (Zhang, et al. (2008) Eur. Food Res. Technol. 226:377-83). Ultrafiltration and membrane contactor (MC) techniques have also been evaluated to recover vanillin (Zabkova, et al. (2007) J. Membr. Sci. 301:221-37; Scuibba, et al. (2009) Desalination 241:357-64). Alternatively, conventional techniques such as percolation or supercritical carbon dioxide extraction and reverse osmosis for concentration could be used.

In some embodiments, the vanillin is isolated and purified to homogeneity (e.g., at least 90%, 92%, 94%, 96%, or 98% pure). In other embodiments, the vanillin is isolated as an extract from a recombinant host. In this respect, vanillin may be isolated, but not necessarily purified to homogeneity. Desirably, the amount of vanillin produced can be from about 1 mg/I to about 20,000 mg/L or higher. For example about 1 to about 100 mg/L, about 30 to about 100 mg/L, about 50 to about 200 mg/L, about 100 to about 500 mg/L, about 100 to about 1,000 mg/L, about 250 to about 5,000 mg/L, about 1,000 to about 15,000 mg/L, or about 2,000 to about 10,000 mg/L of vanillin can be produced. In general, longer culture times will lead to greater amounts of product. Thus, the recombinant microorganism can be cultured for from 1 day to 7 days, from 1 day to 5 days, from 3 days to 5 days, about 3 days, about 4 days, or about 5 days.

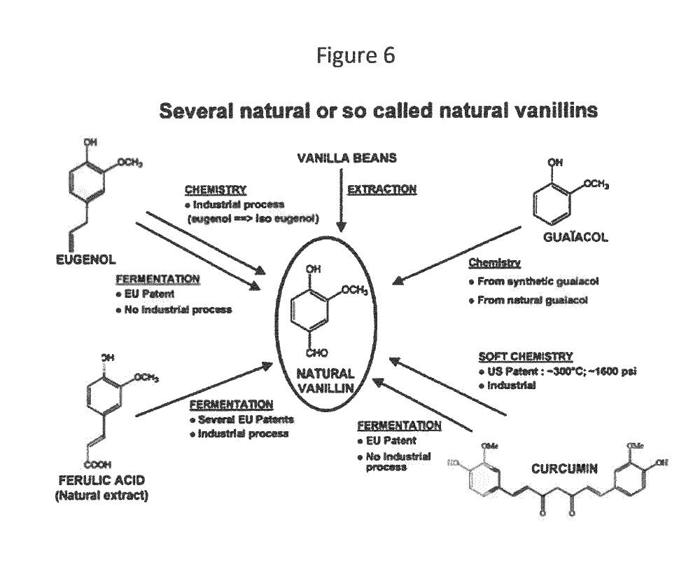

In some embodiments, a vanillin composition has a reduced level of contaminants relative to a vanilla extract or fermented vanillin sample, wherein at least one of said contaminants can be found in Tables 1-4 and FIG. 6.

TABLE 1
Potential classes of contaminants in
a vanilla extract or vanillin sample.

| | Class |
|---|---|
| 1 | pigment |
| 2 | lipid |
| 3 | protein |
| 4 | phenolic |
| 5 | saccharide |
| 6 | monoterpene |
| 7 | labdane-type diterpene |
| 8 | pentacyclic triterpene |
| 9 | sesquiterpene |

TABLE 2
Potential contaminants in a vanilla extract or vanillin sample.

| | Compound |
|---|---|
| 1 | 2-methyloctadecane |
| 2 | 8,11,14-eicosatrienoic acid |
| 3 | α-amyrin |
| 4 | β-amyrin |
| 5 | β-amyrin acetate |
| 6 | β-pinene |
| 7 | β-sitosterol |
| 8 | calcium gluconate |
| 9 | calcium phytate |
| 10 | carboxymethyl cellulose |
| 11 | carnauba wax |
| 12 | carophyllene (and derivatives) |
| 13 | cellulose acetate |
| 14 | Centauredin |
| 15 | copper gluconate |
| 16 | cuprous iodide |
| 17 | decanoic acid |
| 18 | epi-alpha-cadinol |
| 19 | ethyl cellulose |
| 20 | Gibberellin |
| 21 | hydroxypropylmethyl cellulose |
| 22 | Lupeol |
| 23 | Methylcellulose |
| 24 | Octacosane |
| 25 | Octadecanol |
| 26 | Pentacosane |
| 27 | Quercetin |
| 28 | sodium carboxymethyl cellulose |
| 29 | Spathulenol |
| 30 | Stigmasterol |
| 31 | Tetracosane |

TABLE 3
Potential contaminants in a vanilla extract or vanillin sample.

| | Compound |
|---|---|
| 1 | 2-methoxy-4-vinylphenol |
| 2 | 3-bromo-4-hydroxybenzaldehyde |
| 3 | 3-methoxy-4-hydroxybenzyl alcohol |
| 4 | 4-vinylguaiacol |
| 5 | Acetovanillon |
| 6 | coniferyl alcohol |
| 7 | coniferyl aldehyde |
| 8 | Coumarin |
| 9 | dehydro-di-vanillin |
| 10 | ethyl vanillin |
| 11 | Eugenol |
| 12 | ferulic acid |
| 13 | glyoxylic acid |
| 14 | Guaiacol |
| 15 | Isoeugenol |
| 16 | mandelic acid |
| 17 | O-benzylvanillin |
| 18 | Orthovanillin |
| 19 | para-hydroxybenzaldehyde |
| 20 | p-hydroxybenzoic acid |
| 21 | 5-carboxyvanillin |
| 22 | 5-formylvanillin |
| 23 | Curcumin |

TABLE 4
Additional potential compounds in a vanilla extract or vanillin sample.
Compounds

| | | | | |
|---|---|---|---|---|
| 3-buten-2-one | 2,3-butanedione | 2-butanone | Hexane | 2-methyl-3-buten- |
| | | | | 2-ol |
| methyl propionate | tert-amyl alcohol | acetol | 3-methylbutanal | 3-methyl-2- |
| | | | | butanone |
| 2-methylbutanal | 1-butanol | cis-3-penten-2-one | 4,5-dihydro-2- | cis-3-penten-2-ol |
| | | | methylfuran | |
| cyclohexane | propionic acid | 3-hydroxy-2- | 2-ethylfuran | Heptane |
| | | butanone | | |
| anisic aldehyde | 2-methyl-2-butanol | 2-methyl- | 3-methyl-3-buten- | 3-penten-2-ol |
| | | butryraldehyde | 2-one | |
| methyl butyrate | 3-methyl-3- | 3-pentanol | trans-3-penten-2- | propylene glycol |
| | pentanol | | one | |
| isoamyl alcohol | 2-methyl-1-butanol | isobutyric acid | 1-pentanol | 3-methyl-2-butenal |
| toluene | 3-methyl-2-buten- | erythro-2,3- | butanoic acid | threo-2,3- |
| | 1-ol | butanediol | | butanediol |
| hexanal | 2-hexanol | ethyl 2- | Octane | 2-furaldehyde |
| | | hydroxyisobutyrate | | |
| 4-hexen-3-one | 4-hydroxy-4- | 2-furfurol | cis-3-hexen-1-ol | 2-methylbutyric |
| | methyl-2- | | | acid |
| | pentanone | | | |
| 4-cyclopentene- | ethylbenzene | 1-hexanol | 2(5H)-furanone | 3-methylbutyl |
| 1,3-dione | | | | acetate |
| gamma- | pentanoic acid | 3-methyl-2- | Heptanal | 2-acetylfuran |
| butyrolactone | | butenoic acid | | |
| 2,2,4,4- | 2-butoxyethanol | erythro-2,3- | dihydro-3-methyl- | gamma- |
| tetramethyl-3- | | butanediol | 2(3H)-furanone | valerolactone |
| pentanone | | monoacetate | | |
| methyl caproate | threo-2,3- | 3-methylvaleric | 5-methyl-2-furfural | benzaldehyde |
| | butanediol | acid | | |
| | monoacetate | | | |
| alpha-pinene | isopropylbenzene | 1-heptanol | hexanoic acid | 1-octen-3-ol 1- |
| | | | | octen-3-ol |
| 2-octanone | 2-pentylfuran | octanal | 1,2,4- | 3-ethoxyhexanal |
| | | | trimethylbenzene | |
| 5-ethyl-2(5H)- | 3,4-dimethyl-2,5- | 1,1′-dipropylene | 2-hydroxy-3,3- | benzyl alcohol |
| furanone | furandione | glycol 2′-methyl | dimethyl-γ- | |
| | | ether | butyrolactone | |
| gamma- | phenylacetaldehyde | 3-octen-2-one | p-isopropyltoluene | 2-hydroxybenzaldehyde |
| hexalactone | | | | |
| 2,2,6- | 2-methylphenol | 2-furoic acid | acetophenone | 3,5-octadien-2-one |
| trimethylcyclohexanone | | | | |
| 4-methylphenol | 2-(hydroxyacetyl)furan | 2-octen-1-ol | heptanoic acid | methyl benzoate |
| 6-methyl-3,5- | 3-hydroxy-2- | nonanal | phenethanol | 2-ethylhexanoic |
| heptadien-2-one | methylpyran-4-one | | | acid |
| undecane | methyl octanoate | 2-vinylanisole | 1,2- | 4-methyl-5,6- |
| | | | dimethoxybenzene | dihydro-2- |
| | | | | pyranone |
| 2,4-dimethylphenol | benzyl acetate | benzoic acid | octanoic acid | 4-ethylbenzaldehyde |
| 1-nonanol | 3,5-dihydroxy-2- | 2-methoxy-4- | naphthalene | 5-(hydroxymethyl)- |
| | methylpyran-4-one | methylphenol | | 2-furfural |
| dehydro-β- | p-vinylphenol | 4,6,6-trimethylbi- | octyl acetate | dodecane |
| cyclocitral | | cyclo[3.1.1]hept- | | |
| | | 3-en-2-one | | |
| 3-phenylfuran | methyl nonanoate | 3-phenyl-1- | 1,2-dimethoxy-4- | phenylacetic acid |
| | | propanol | methylbenzene | |
| γ-octalactone | 4-methoxybenzaldehyde | 4-allylphenol | phenethyl acetate | trans- |
| | | | | cinnamaldehyde |
| nonanoic acid | methyl 3- | p-methoxybenzyl | 4-ethylguaiacol | p-hydroxybenzyl |
| | phenylpropionate | alcohol | | methyl ether |
| methyl cis- | 3-methyl-5-propyl- | 1,4-benzenediol | 1-methylnaphthalene | 2-methoxy-4- |
| cinnamate | 2-cyclohexen-1-one | | | vinylphenol |
| cis-dihydroedulan | tridecane | heliotropine | 2-methylnaphthalene | methyl decanoate |
| 2,6- | γ-nonalactone | benzylidene | 4-allyl-2- | p-hydroxybenzaldehyde |
| dimethoxyphenol | | acetone | methoxyphenol | |
| methyl p- | methyl trans- | 4-(hydroxymethyl)- | α-copaen | tetradecane |
| methoxybenzoate | cinnamate | 2-methoxyphenol | | |
| | | methyl ether | | |
| 2,5- | trans-cinnamic | cis-α-bergamotene | α-gurjunene | methyl 4- |
| dihydroxybenz- | acid | | | hydroxybenzoate |
| aldehyde | | | | |
| 2-ethylnaphthalene | α-santalene | 4-hydroxy-3- | α-D-curcumene | 4-(hydroxymethyl)- |
| | | methoxybenzyl | | 2-methoxyphenol |
| | | alcohol | | alcohol ethyl ether |
| trans-α- | ethyl trans- | germacrene D | vanillin acetate | methyl vanillinate |
| bergamotene | cinnamate | | | |
| pentadecane | 3,4-dimethyl-5- | 4-hydroxy-3- | γ-cadinene | methyl |
| | pentylidene-2(5H)- | methoxyphenylacetone | | dodecanoate |
| | furanone | | | |
| valencene | calamenene | δ-cadinene | 4-hydroxy-3- | α-calacorene |
| | | | methoxybenzoic acid | |
| 4-ethoxy-3- | diethyl phthalate | trans-nerolidol | hexadecane | 3,5-dimethoxy-4- |
| methoxybenzaldehyde | | | | hydroxybenzaldehyde |
| erythro-vanillin- | threo-vanillin- | erythro-vanillin | threo-vanillin 2,3- | octadecane |
| propylene glycol | propylene glycol | 2,3-butanediol | butanediol acetal | |
| acetal | acetal | acetal | | |
| 6,10,14-trimethyl- | nonadecane | methyl | dibutyl phthalate | ethyl palmitate |
| 2-pentadecanone | | hexadecanoate | | |
| methyl trans- | cembrene | heneicosane | p-(p-hydroxy- | docosane |
| 9,trans-12- | | | phenoxy)benzoic | |
| octadecadienoate | | | acid | |
| cis-9-tricosene | tricosane | hexanedioic acid, | tetracosane | pentacosane |
| | | bis(2-ethylhexyl) | | |
| | | ester | | |
| dioctyl phthalate | cis-18- | cis-20- | isovaleric acid | 4-(2-propenyl0- |
| | heptacosene-2,4- | nonacosene-2,4- | | 2,6- |
| | dione | dione | | dimethoxyphenol |
| valeraldehyde | acetal | 4-methyl-2- | 2-methyl-2- | N-amyl alcohol |
| | | pentanone | butenal | |
| 3-methyl-2-buteno- | ethyl butyrate | hexanal | ethyl lactate | furfural |
| 1-ol | | | | |
| 2-methylpentanoic | N-butyraldehyde | isobutyraldehyde | diethyl acetal | N-hexanol |
| acid | diethyl acetal | | | |
| valeric acid | 2-heptanone | dihydro-2(3H)- | isovaleraldehyde | 4-methylfurfural |
| | | furanone | diethyl acetal | |
| caproic acid, | 1-octen-3-ol | valeraldehyde | ethyl caproate, | 1H-pyrrole-2- |
| | | diethyl acetal | octanal | carboxaldehyde |
| furfuryl alcohol | p-cymene | D-limonene | benzyl alcohol | gamma- |
| | | | | hexalactone |
| gamma-terpinene | heptanoic acid | 1-octanol | P-cresol | hexanal diethyl |
| | | | | acetal |
| linalool | 3,4- | ethyl heptanoate | 4-methoxyphenol | trans-carveol |
| | dimethoxytoluene | | | |
| phenyl ethanol | veratrole | caprylic acid | 3-ethyl phenol | diethyl succinate |
| ethyl benzoate | 3-methyl-1H- | 1,-4- | 2-octenoic acid | alpha-terpineol |
| | pyrazole | dimethoxybenzene | | |
| methyl salicylate | 4-methyl | 2,3- | 5-(hydroxy- | hydrocinnamyl |
| | benzaldehyde | dihydrobenzofuran | methyl)furfural | alcohol |
| hydrocinnamyl | 3-methyl benzoic | phenylacetic acid | nonanoic acid | P-anisaldehyde |
| alcohol | acid | | | |
| cinnamaldehyde | P-anisyl alcohol | 4-methoxy-2- | 2,3-dihydro-1H- | 4-hydroxybenzyl |
| | | methyl phenol | inden-1-one | methyl ether |
| 1,2,3- | cinnamyl alcohol | 1,4-benzenediol | phenylpropanoic | decanoic acid |
| trimethoxybenzene | | | acid | |
| 2,6- | gamma- | 4-ethoxy-2- | P-hydroxybenzaldehyde | methyl p-anisate |
| dimethoxyphenol | nonalactone | methylphenol | | |
| methyl cinnamate | 2-methoxy-1,4- | eugenyl methyl | P-anisic acid | cinnamic acid |
| | benzenediol | ether | | |
| methyl 4- | acetovanillone | isoeugenyl acetate | lauric acid | 2-methyl-4,5- |
| hydroxybenzoate | | | | dimethoxyphenol |
| 2-methyl-1,1′- | 5,6-dihydro-7,12- | 3-methyl phenol | 4-methyldibenzofuran | syringaldehyde |
| biphenyl | dimethyl- | | | |
| | benz[a]anthracene- | | | |
| | 5,6-diol | | | |
| 1,1′-bis(p- | 2,3,4- | acetosyringone | myristic acid | 9H-fluoren-9-one, |
| tolyl)ethane | trimethoxyacetophenone | | | octacosane |
| 1H-indole-3- | pentadecanoic | palmitic acid | ethyl palmitate | 4,4′- |
| carboxaldehyde | acid | | | methylenebisphenol |
| ethyl linoleate | ethyl pyruvate | ethyl propionate | | |

In some embodiments, the compounds in Tables 2-4, which include contaminating compounds, can, inter alia, contribute to off-flavors. Table 2 includes compounds Generally Recognized as Safe (GRAS). Table 3 includes compounds presented in the literature as being present in fermentation-derived vanillin compositions and in vanilla extracts. Table 4 includes compounds found in vanilla extracts from plants grown in Madagascar, Uganda, and Indonesia. See e.g. Zhang and Mueller, J. Agric. Food Chem. 60: 10433-44 (2012).

In some embodiments, the culture medium of a recombinant host does not comprise one or a plurality of the compounds of Tables 1-4 prior to fermentation. In some embodiments, the culture medium of a recombinant host does not comprise one or a plurality of the compounds of Tables 1-4 after fermentation.

### Method for Analysis of Vanillin

Vanillin compositions produced herein can be analyzed using methods known in the art including, but not limited to, liquid chromatography-mass spectrometry (LC-MS), gas chromatography-mass spectrometry (GC-MS), nuclear magnetic resonance (NMR), and infrared spectroscopy (IR). LC-MS of analysis of vanillin and vanillin precursors is described in Jager et al., Journal of Chromatography A. 1145: 83-8 (2007), which is incorporated by reference in its entirety.

For example, mass spectrometry (MS) provides qualitative and/or quantitative data by measuring the masses and abundances of ions in the gas phase. MS can be used to determine properties such as molecular weight, molecular structure, mixture components, sample concentration, and sample purity. This sensitive technique can also be used to measure reaction progress and distinguish between substances with the same retention time. A mass spectrometer is composed of (a) an ion source, (b) a mass analyzer, and (c) a detector. Prior to separation in the mass spectrometer, molecules are ionized; two methods used to ionize molecules are electron ionization and chemical ionization. An electric field deflects ions in complicated trajectories while migrating from the ionization chamber to the detector. Altering the voltage applied to the mass separator allows for ions of particular mass-charge ratios to reach the detector. Several types of mass analyzers are currently used including time of flight (TOF), quadrupole, ion trap, Fourier transform ion cyclotron resonance. In gas chromatography (GC) and liquid chromatography (LC) applications, a mass spectrometer is the most powerful detector. For additional information on MS systems and methods, see U.S. Pat. No. 8,399,826 and PCT/JP2011/080024, which are incorporated by reference in their entirety.

### Food Products

Vanillin obtained by the methods disclosed herein can be used to make food and beverage products, and dietary supplements.

Compositions produced by a recombinant microorganism described herein can be incorporated into food products. For example, a vanillin composition produced by a recombinant organism can be incorporated into a food product in an amount ranging from about 1.5 mg vanillin/kg food product to about 2000 mg vanillin/kg food product on a dry weight basis, depending on the type of food product. For example, a vanillin composition produced by a recombinant organism can be incorporated into a cold confectionary (e.g., ice cream), hard candy, or chocolate such that the food product has a maximum of about 95 mg/kg, 200 mg/kg, or 970 mg vanillin/kg food on a dry weight basis, respectively. A vanillin composition produced by a recombinant microorganism can be incorporated into a baked good (e.g., a biscuit) such that the food product has a maximum of about 200 mg vanillin/kg food on a dry weight basis. A vanillin composition produced by a recombinant microorganism can be incorporated into a beverage (e.g., a carbonated beverage) such that the beverage has a maximum of about 100 mg vanillin/kg. Vanillin sugar sold in supermarkets contains about 12500 mg vanillin/kg. See e.g., FEMA, Scientific Literature Review of Vanillin and Derivatives (1985).

The invention will be further described in the following examples, which do not limit the scope of the invention described in the claims.

### EXAMPLES

The Examples that follow are illustrative of specific embodiments of the invention and various uses thereof. They are set forth for explanatory purposes only and are not to be taken as limiting the invention.

### Example 1: Construction of an AROM Lacking Domain 5

The 5′-nearest 3912 bp of the yeast ARO1 gene, which includes all functional domains except domain 5 (having the shikimate dehydrogenase activity), was isolated by PCR amplification from genomic DNA prepared from S. cerevisiae strain S288C, using proof-reading PCR polymerase. The resulting DNA fragment was sub-cloned into the pTOPO vector and sequenced to confirm the DNA sequence. The nucleic acid sequence and corresponding amino acid sequence are presented in SEQ ID NO:1 and SEQ ID NO:2, respectively. This fragment was subjected to a restriction digest with SpeI and SalI and cloned into the corresponding restriction sites in the high copy number yeast expression vector p426-GPD (a 2μ-based vector), from which the inserted gene can be expressed by the strong, constitutive yeast GPDI promoter. The resulting plasmid was designated pVAN133.

### Example 2: Yeast AROM with Single Amino Acid Substitutions in Domain 5

All mutant AROM polypeptides described in this example are polypeptides of SEQ ID NO:4, wherein one amino acid has been substituted for another amino acid. The mutant AROM polypeptides are named as follows: XnnnY, where nnn indicates the position in SEQ ID NO:4 of the amino acid, which is substituted, X is the one letter code for the amino acid in position nnn in SEQ ID NO:4 and Y is the one letter code for the amino acid substituting X. By way of example A1533P refers to a mutant AROM polypeptide of SEQ ID NO:4, where the alanine at position 1533 is replaced with a proline.

The full 4764 bp yeast ARO1 gene was isolated by PCR amplification from genomic DNA prepared from S. cerevisiae strain S288C, using proof-reading PCR polymerase. The resulting DNA fragment was sub-cloned into the pTOPO vector and sequenced to confirm the DNA sequence. The nucleic acid sequence and corresponding amino acid sequence are presented in SEQ ID NO:3 and SEQ ID NO:4, respectively. This fragment was subjected to a restriction digest with SpeI and Sail and cloned into the corresponding restriction sites in the low copy number yeast expression vector p416-TEF (a CEN-ARS-based vector), from which the gene can be expressed from the strong TEF promoter. The resulting plasmid was designated pVAN183.

Plasmid pVANI83 was used to make 10 different domain 5 mutants of ARO1, using the QUICKCHANGE II Site-Directed Mutagenesis Kit (Agilent Technologies). With reference to SEQ ID NO:4, the mutants contained the following amino acid substitutions: A1533P, P1500K, R1458W, V1349G, T1366G, I1387H, W1571V, T1392K, K1370L and A1441P.

After sequence confirmation of these mutant AROM genes, the expression plasmids containing the A1533P, P1500K, R1458W, V1349G, T1366G, I1387H, W1571V, T1392K, K1370L and A1441P substitutions were designated pVAN368-pVAN377, respectively.

### Example 3: Yeast AROM and 3DHS Dehydratase Fusion Protein

The 5′-nearest 3951 bp of the yeast ARO1 gene, which includes all functional domains except domain 5 with the shikimate dehydrogenase activity, was isolated by PCR amplification from genomic DNA prepared from S. cerevisiae strain S288C, using proof-reading PCR polymerase. The resulting DNA fragment was sub-cloned into the pTOPO vector and sequenced to confirm the DNA sequence. In order to fuse this fragment to the 3-dehydroshikimate dehydratase (3DSD) gene from the vanillin pathway, the 3DSD gene from P. pauciseta (Hansen, et al. (2009) supra) was inserted into the Xmal-EcoRI sites of yeast expression vector p426-GPD, and then the cloned ARO1 fragment was liberated and inserted into the Spel-Xmal sites of the resulting construct. The final fusion gene is expressed from the strong, constitutive yeast GPDI promoter. The resulting plasmid was named pVAN132. The nucleic acid sequence and corresponding amino acid sequence of this fusion protein are presented in SEQ ID NO:6 and SEQ ID NO:7, respectively.

### Example 4: Reduction of 4-(Hydroxymethyl)-2-Methoxyphenol Alcohol

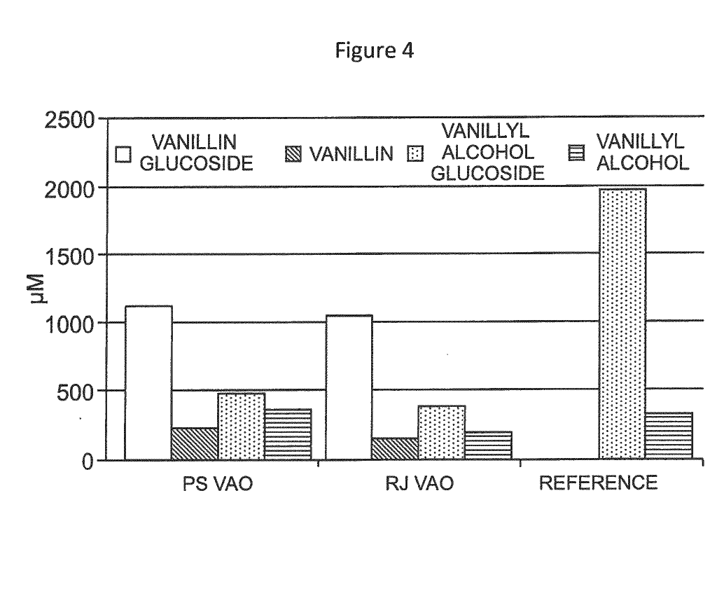

By way of illustration, P. simplicissium (GENBANK Accession No. P56216) and R. jostii (GENBANK Accession No. YP_703243.1) VAO genes were isolated and cloned into a yeast expression vector. The expression vectors were subsequently transformed into a yeast strain expressing glucosyltransferase. The transformed strains were tested for VAO activity by growing the yeast for 48 h in medium supplemented with 3 mM 4-(hydroxymethyl)-2-methoxyphenol alcohol. The results of this analysis are presented in FIG. 4. VAO enzymes from both P. simplicissium and R. jostii exhibited activity in yeast. When the VAO enzymes were analyzed in a strain capable of producing vanillin glucoside, there was a reduction in the accumulation of 4-(hydroxymethyl)-2-methoxyphenol alcohol during vanillin glucoside fermentation.

### Example 5: ACAR Gene from N. crassa

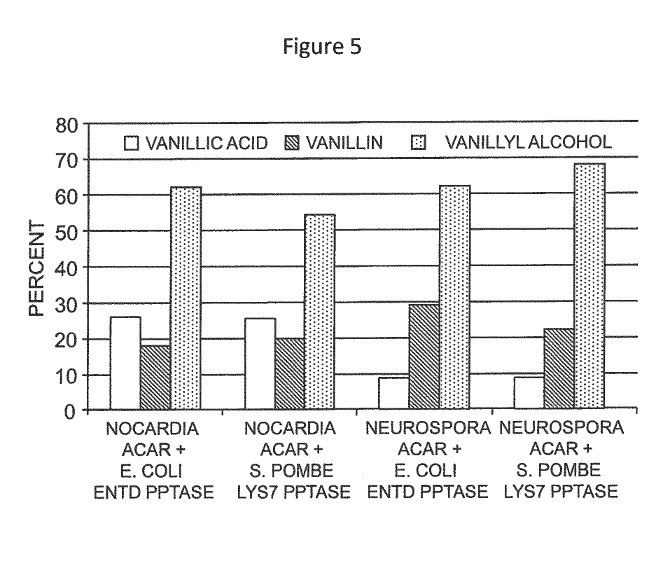

As an alternative to an ACAR protein (EC 1.2.1.30) from N. iowensis (Hansen, et al. ((2009) Appl. Environ. Microbiol. 75:2765-74), the use of a N. crassa ACAR enzyme (Gross & Zenk (1969) Eur. J. Biochem. 8:413-9; U.S. Pat. No. 6,372,461) in yeast was investigated, as Neurospora (bread mold) is a GRAS organism. An N. crassa gene (GENBANK XP_955820) with homology to the N. iowensis ACAR was isolated and cloned into a yeast expression vector. The vector was transformed into a yeast strain expressing a PPTase, strains were selected for the presence of the ACAR gene, and the selected yeast was cultured for 72 h in medium supplemented with 3 mM vanillic acid to demonstrate ACAR activity. The results of this analysis are presented in FIG. 5. The N. crassa ACAR enzyme was found to exhibit a higher activity in yeast than the N. iowensis ACAR. Therefore, in some embodiments of the method disclosed herein, a N. crassa ACAR enzyme is used in the production of vanillin.

In addition to N. iownsis or N. crassa ACAR proteins, it is contemplated that other ACAR proteins may be used, including but not limited to, those isolated from Nocardia brasiliensis (N. brasiliensis; GENBANK Accession No. EHY26728), N. farcinica (GENBANK Accession No. BAD56861), P. anserina (GENBANK Accession No. CAP62295), or Sordaria macropora (S. macropora; GENBANK Accession No. CCC14931), which significant sequence identity with the N. iownsis or N. crassa ACAR protein.

### Example 6: Mass Spectrometry Analysis of Vanillin Produced by Fermentation

The following methodology was used to analyze vanillin and potential vanillin contaminants. 1 mg of each sample was solubilized in 1 mL methanol. Liquid Chromatography-Mass Spectrometer (LC-MS) analyses were performed using an Acquity UPLC® system (Waters) fitted with an Acquity UPLC® BEH C18 column (100×2.1 mm, 1.7 μm particles; Waters) connected to a MicroOTOF II (Bruker) mass spectrometer. Elution was carried out using a mobile phase of eluent A (0.1% Formic acid in water) and eluent B (0.1% Formic acid in Acetonitrile) by increasing the gradient from 1→50% B from min 0.0 to 3.0 and increasing the gradient from 50→100% B in min 3.0 to 4.0. Vanillin, potential vanillin contaminants, and analytical standards (the latter purchased from Sigma) were detected using SIM (Single Ion Monitoring) in positive mode.

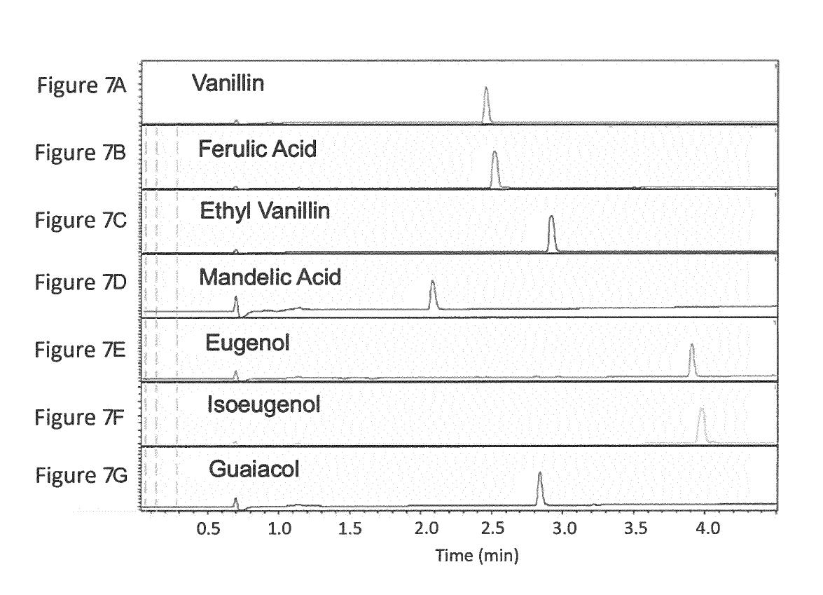

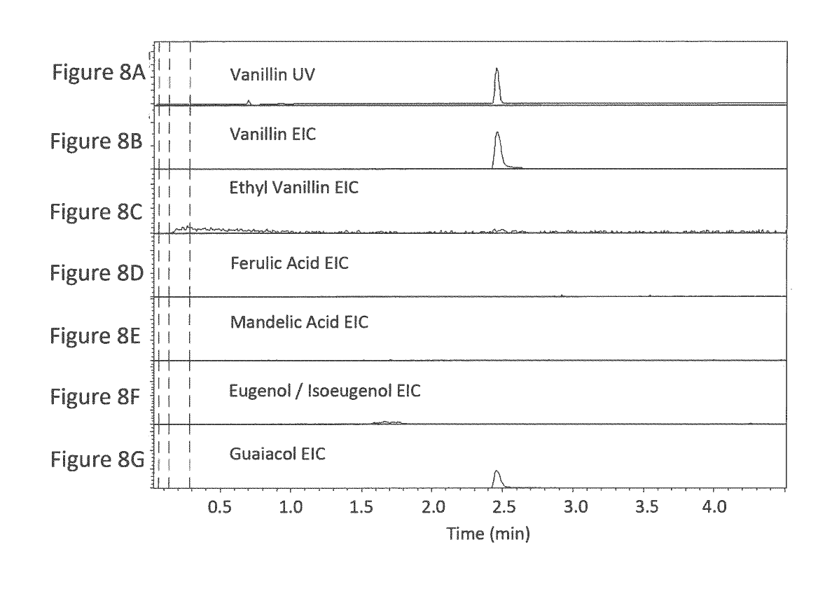

The UV traces of analytical standards of vanillin, ferulic acid, ethyl vanillin, mandelic acid, eugenol, isoeugenol, and guiacol are shown in FIG. 7, and the extracted ion chromatograms of each of the compounds can be found in FIG. 8. The retention time is shown on the x-axis, and the peak intensity on the y-axis is proportional to the amount of compound detected. All samples in FIG. 7 were analyzed under identical chromatographic conditions, and all UV traces show the relative positions of vanillin, ferulic aid, ethyl vanillin, mandelic acid, eugenol, isoeugenol, and guiacol peaks relative to each other. The expected and observed mono isotopic mass values for vanillin and each analytical standard can be found in Table 5.

TABLE 5
Isotopic mass values.

| | | | | Observed |
|---|---|---|---|---|
| | | | Expected | Mono |
| | | | Mono | isotopic |
| | | | isotopic | Mass |
| | Systematic Name | CAS | Mass [M] | [M + H]⁺ |
| Vanillin | 4-Hydroxy-3- | 121-33-5 | 152.047348 | 153.0470 |
| | methoxybenz- | | | |
| | aldehyde | | | |
| Ferulic Acid | (2E)-3-(4-Hydroxy- | 537-98-4 | 194.057907 | 195.0552 |
| | 3-methoxyphe- | | | |
| | nyl)acrylic acid | | | |
| Ethyl | 3-Ethoxy-4- | 121-32-4 | 166.062988 | 167.0625 |
| Vanillin | hydroxybenz- | | | |
| | aldehyde | | | |
| Mandelic | Hydroxy(phe- | 90-64-2 | 152.047348 | 135.0372 |
| Acid | nyl)acetic acid | | | |
| Eugenol | 4-Allyl-2- | 97-53-0 | 164.083725 | 165.0825 |
| | methoxyphenol | | | |
| Isoeugenol | 2-Methoxy-4- | 97-54-1 | 164.083725 | 165.0827 |
| | [(1E)-1-propen- | | | |
| | 1-yl]phenol | | | |
| Guaiacol | 2-Methoxyphenol | 90-05-1 | 124.052429 | 125.0534 |

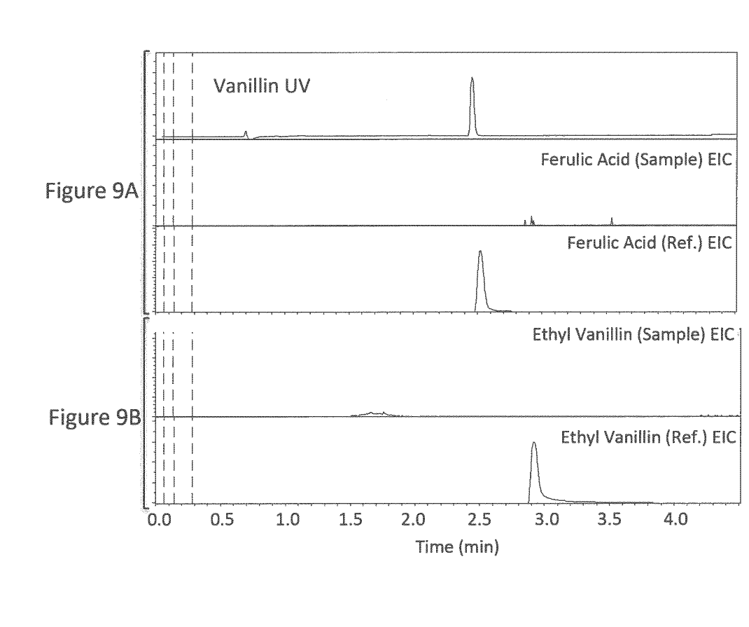

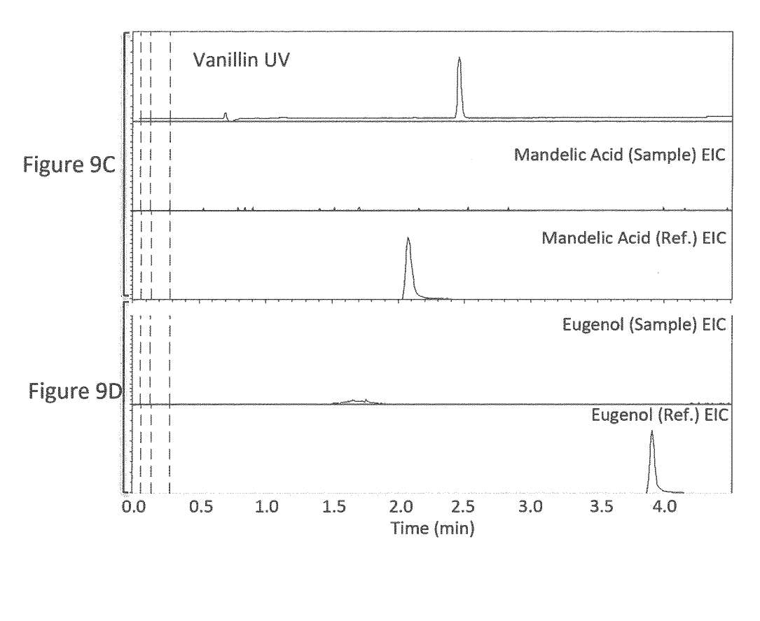

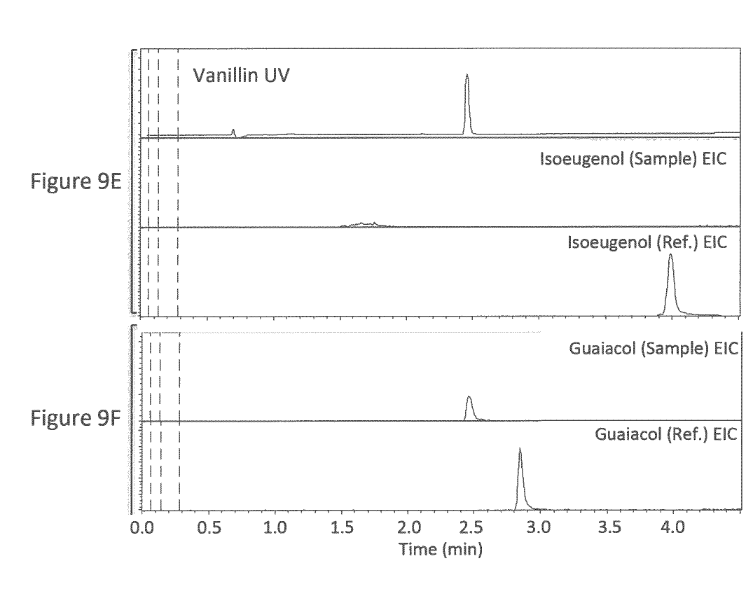

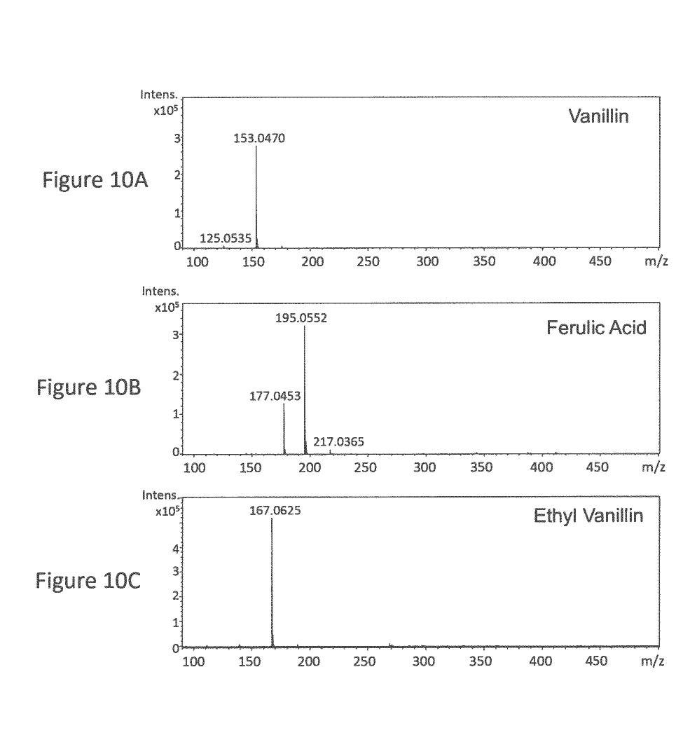

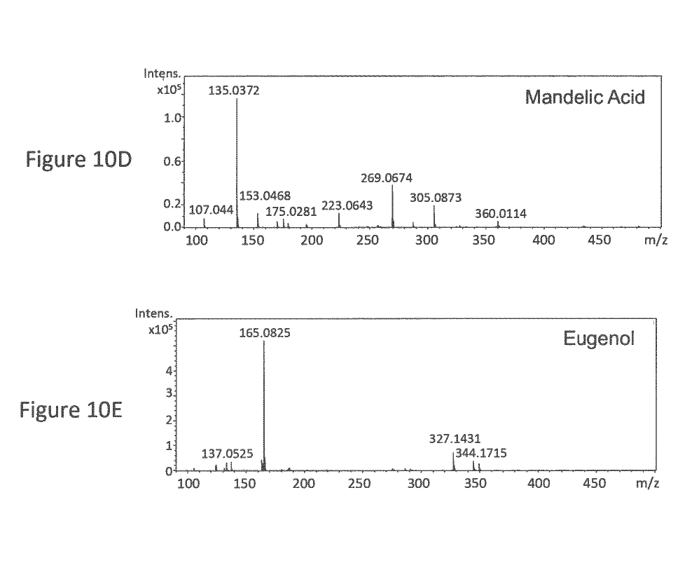

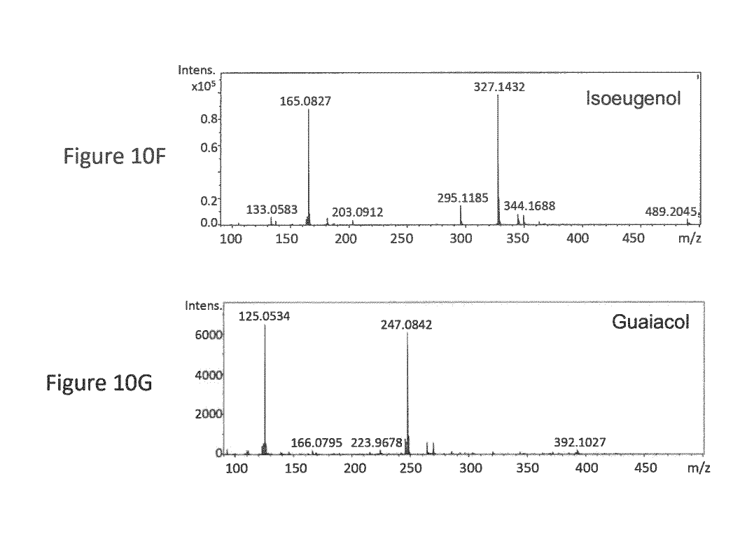

The compounds are considered present in the sample if they have the same retention time as well as the same monoisotopic mass value. The extracted ion chromatograms in FIG. 8 do not show presence of ferulic acid, ethyl vanillin, mandelic acid, eugenol, isoeugenol, and guiacol in the vanillin sample produced by fermentation. The peak in FIG. 8 eluting at 2.45 min represents a fragment of the vanillin ion and does not represent presence of guaiacol, which elutes at 2.85 min. Additional comparisons between the extracted ion chromatograms of the vanillin sample and the ferulic acid, ethyl vanillin, mandelic acid, eugenol, isoeugenol, and guiacol analytical standards can be found in FIG. 9. The fingerprint mass spectra of all the aforementioned compounds are shown in FIG. 10.

Furthermore, coumarin, hydroxybenzaldehyde, hydroxylbenzoic acid, 4-vinylguiacol, acetovanillone, curcumin, and intermediates of the curcuin-to-vanillin pathway were also not detected in the vanillin sample produced herein by fermentation, further illustrating the purity of the sample.

Having described the invention in detail and by reference to specific embodiments thereof, it will be apparent that modifications and variations are possible without departing from the scope of the invention defined in the appended claims. More specifically, although some aspects of the present invention are identified herein as particularly advantageous, it is contemplated that the present invention is not necessarily limited to these particular aspects of the invention.

1. A vanillin composition comprising from about 1% to about 99.9% w/w of vanillin, wherein the composition has a reduced level of contaminants relative to a plant-derived vanillin extract or a vanillin composition produced by an in vitro process, by whole cell bioconversion, or by fermentation.

2. The composition of claim 1, wherein at least one of said contaminants is a compound that contributes to off-flavors.

3. The composition of claim 1, wherein the composition has less than 0.1% of contaminants relative to a plant-derived vanillin extract or a vanillin composition produced the in vitro process, by whole cell bioconversion, or by fermentation.

4. The composition of claim 3, wherein at least one of said contaminants is a compound that contributes to off-flavors.

5. The composition of claim 1, wherein the composition contains a reduced amount of one or a plurality of 2-methoxy-4-vinylphenol, 3-bromo-4-hydroxybenzaldehyde, 3-methoxy-4-hydroxybenzyl alcohol, 4-vinylguaiacol, acetovanillon, coniferyl alcohol, coniferyl aldehyde, coumarin, dehydro-di-vanillin, ethyl vanillin, eugenol, ferulic acid, glyoxylic acid, guaiacol, isoeugenol, mandelic acid, O-benzylvanillin, orthovanillin, para-hydroxybenzaldehyde, p-hydroxybenzoic acid, 5-carboxyvanillin, 5-formylvanillin, turmeric, and/or 4-(hydroxymethyl)-2-methoxyphenol.

6. The composition of claim 1, wherein the composition contains a reduced amount of one or a plurality of 2-methyloctadecane, 8,11,14-eicosatrienoic acid, α-amyrin, β-amyrin, β-amyrin, acetate, β-pinene, β-sitosterol, calcium gluconate, calcium phytate, carboxymethyl cellulose, carnauba wax, carophyllene, carophyllene derivatives, cellulose acetate, centauredin, copper gluconate, cuprous iodide, decanoic acid, epi-alpha-cadinol, ethyl cellulose, gibberellin, hydroxypropylmethyl cellulose, lupeol, methylcellulose, octacosane, octadecanol, pentacosane, quercetin, sodium carboxymethyl cellulose, spathulenol, stigmasterol, and/or tetracosane.

7. The composition of claim 1, wherein the composition contains a reduced amount of one or a plurality of compounds of Table 4.

8.-14. (canceled)

15. The composition of claim 1, wherein the composition does not comprise one or a plurality of 2-methoxy-4-vinylphenol, 3-bromo-4-hydroxybenzaldehyde, 3-methoxy-4-hydroxybenzyl alcohol, 4-vinylguaiacol, acetovanillon, coniferyl alcohol, coniferyl aldehyde, coumarin, dehydro-di-vanillin, ethyl vanillin, eugenol, ferulic acid, glyoxylic acid, guaiacol, isoeugenol, mandelic acid, O-benzylvanillin, orthovanillin, para-hydroxybenzaldehyde, p-hydroxybenzoic acid, 5-carboxyvanillin, 5-formylvanillin, turmeric, and/or 4-(Hydroxymethyl)-2-methoxyphenol.

16. The composition of claim 1, wherein the composition does not comprise one or a plurality of compounds of Table 4.

17. (canceled)

18. A food product comprising the composition according to claim 1.

19. The food product of claim 18, wherein the food product is a beverage or a beverage concentrate.

20.-22. (canceled)

23. The composition of claim 1, wherein the composition does not comprise one or a plurality of:
(a) 2-methoxy-4-vinylphenol;
(b) 3-bromo-4-hydroxybenzaldehyde;
(c) 3-methoxy-4-hydroxybenzyl alcohol;
(d) 4-vinylguaiacol;
(e) acetovanillon;
(f) coniferyl alcohol;
(g) coniferyl aldehyde;
(h) coumarin;
(i) dehydro-di-vanillin;
(j) ethyl vanillin;
(k) eugenol;
(l) ferulic acid
(m) glyoxylic acid;
(n) guaiacol;
(o) isoeugenol;
(p) mandelic acid;
(q) O-benzylvanillin;
(r) orthovanillin;
(s) para-hydroxybenzaldehyde;
(t) p-hydroxybenzoic acid;
(u) 5-carboxyvanillin;
(v) 5-formylvanillin;
(w) turmeric;
(x) 4-(Hydroxymethyl)-2-methoxyphenol, or
(y) one or a plurality of compounds of Table 4.

24. The composition of claim 23, wherein the composition does not comprise 2-methoxy-4-vinylphenol.

25. The composition of claim 23, wherein the composition does not comprise 3-bromo-4-hydroxybenzaldehyde.

26. The composition of claim 23, wherein the composition does not comprise 3-methoxy-4-hydroxybenzyl alcohol.

27. The composition of claim 23, wherein the composition does not comprise 4-vinylguaiacol.

28. The composition of claim 23, wherein the composition does not comprise acetovanillon.

29. The composition of claim 23, wherein the composition does not comprise coniferyl alcohol.

30. The composition of claim 23, wherein the composition does not comprise coniferyl aldehyde.

31. The composition of claim 23, wherein the composition does not comprise coumarin.

32. The composition of claim 23, wherein the composition does not comprise dehydro-di-vanillin.

33. The composition of claim 23, wherein the composition does not comprise ethyl vanillin.

34. The composition of claim 23, wherein the composition does not comprise eugenol.

35. The composition of claim 23, wherein the composition does not comprise ferulic acid.

36. The composition of claim 23, wherein the composition does not comprise glyoxylic acid.

37. The composition of claim 23, wherein the composition does not comprise guaiacol.

38. The composition of claim 23, wherein the composition does not comprise isoeugenol.

39. The composition of claim 23, wherein the composition does not comprise mandelic acid.

40. The composition of claim 23, wherein the composition does not comprise O-benzylvanillin.

41. The composition of claim 23, wherein the composition does not comprise orthovanillin.

42. The composition of claim 23, wherein the composition does not comprise para-hydroxybenzaldehyde.

43. The composition of claim 23, wherein the composition does not comprise p-hydroxybenzoic acid.

44. The composition of claim 23, wherein the composition does not comprise 5-carboxyvanillin.

45. The composition of claim 23, wherein the composition does not comprise 5-formylvanillin.

46. The composition of claim 23, wherein the composition does not comprise turmeric.

47. The composition of claim 23, wherein the composition does not comprise 4-(Hydroxymethyl)-2-methoxyphenol.

48. The composition of claim 23, wherein the composition does not comprise one or a plurality of compounds of Table 4.

49.-54. (canceled)
